(19) United States
(12) Patent Application Publication
(10) Pub. No.: US 2014/0067702 A1
(43) Pub. Date: Mar. 6, 2014

(54) Method and System for Dynamically Publishing, Sharing, Communication and Subscribing

(71) Applicant: Yogesh Chunilal Rathod, Mumbai (IN)

(72) Inventor: Yogesh Chunilal Rathod, Mumbai (IN)

(21) Appl. No.: 14/008,192

(22) PCT Filed: Mar. 29, 2011
(86) PCT No.: PCT/IB11/51318

§ 371 Date: Nov. 21, 2013

(51) Int. Cl. G06Q 50/00; G06Q 10/00

(52) U.S. Cl. CPC G06Q 50/01; G06Q 10/00
USPC 705/319

(57) ABSTRACT

A system & method for dynamically publishing, sharing, communication & subscribing and dynamically presenting and allow to auto subscribe publisher specific active links and associate objects & data of other services, applications, networks, groups, widgets & objects of publishers to users of network is described. A method includes dynamically present selected publishing type or service specific input system, presentations and application features to publisher and subscriber for managing publishing specific contents, shared data, communications & messages, subscribers, privacy settings, user actions, workflow and managing subscribed contents, communications, messages, subscriptions, privacy settings, user actions, workflow. A method further includes publisher can dynamically publish active links and associate objects & data for other services, applications, web site features, widgets, objects, multimedia contents of publisher and allow users of network to search, select, subscribe or auto install & attach said active links with user profile based on privacy settings.

### COPYRIGHTS INFORMATION

A portion of the disclosure of this patent document contains material that is subject to copyright protection. The copyright owner has no objection to the facsimile reproduction by anyone of the patent document or the patent disclosure, as it appears in the Patent and Trademark Office patent file, but otherwise reserves all copyright rights whatsoever. The applicant acknowledges the respective rights of various Intellectual property owners.

### FIELD OF INVENTION

The present invention relates generally to dynamically publishing, sharing, communication & subscribing and dynamically presenting and allow to auto subscribe publisher specific active links and associate objects & data of other services, applications, networks, groups, widgets & objects of publishers to users of network.

### BACKGROUND OF THE INVENTION

Conventionally, a user of a networking web site can send message, micro blogging, update status, share resources including photos, videos, text contents & links and publish contents via different web sites, applications and services and connected or subscribed users receives said shared & published contents in different web sites, applications and services.

There are existing mechanisms that allow a user to publish and share contents to other users. Some mechanisms may allow the user to select particular publishing and sharing features for publishing and sharing contents with other users. Typically, however, these published and shared contents are disparate and disorganized. In other words, the user must spend time researching shared and subscribed contents by searching for, identifying, and reading individual shared and subscribed contents that are not presented in a coherent, consolidated manner. Often, many of the shared and subscribed contents are not relevant to the user. Just as often, the user remains unaware of the existence of some shared and subscribed contents that were not captured in the user's research. What is needed is a dynamically publishing, sharing, posting, subscribing & presenting shared & published contents and accessing publishing type specific features.

Presently, a user of a networking web site can subscribe one or more publishers for receiving messages, micro blogs, blogs, and updated status, shared contents. User can read said subscribed contents & messages. But user cannot participate, collaborate, communicate, workflow, transact with publishers or others based on said received contents & messages and users are not able to access, install and subscribe other services of said interested publishers.

Present invention solves said problems and provides mechanisms to attaching one or more active links and associate objects & data with message and provides mechanisms for search, select, access install, subscribe publisher specific global active links and associate objects & data, wherein said one or more active links and associate objects & data enables user to communicate, collaborate, answer, share, search, workflow, take one or more actions, transact, e-commerce, create social networks and participate with publishers or 3^{rd} parties networks, users, services, devices and applications.

### OBJECT OF THE INVENTION

The principal object of the present invention is to facilitating publisher to dynamically publish one or more publishing types specific publications to subscribers in user-friendly, personalized, customized, unified and integrated manner based on dynamic publishing type specific input system, presentation and application features.

Another significant objective of the present invention is to dynamically present subscribed contents to subscribers and allowing subscriber to dynamically view, access said subscribed contents based on publishing type or publication or publisher specific dynamic presentation system and application features.

Yet another important objective of the present invention is to allow user to attach one or more active links and associate objects & data with published contents or messages, wherein said one or more active links and associate objects & data enables user to communicate, collaborate, answer, share, search, workflow, take one or more actions, transact, e-commerce, create social networks and participate with publishers or 3^{rd} parties networks, users, services, devices and applications.

Yet another important objective of the present invention is to allow publisher to publish other services of publishers and associate active links, active links associate objects & objects associate data with one or more publishing services and allow to auto install, subscribe, access & attach said other services to subscriber user's profile or other prominent places. User can manually search, filter, bookmark, select, share, sort, install, attach, detach, remove, categories and subscribe said one or more publishers specific one or more other services and associate one or more global active links, active links associate objects & objects associate data.

Yet another important objective of the present invention is to enable users to dynamically and automatically install, subscribe to or presenting lists for user selections of one or more applications, services, web sites, networks, widgets, groups, networks and attach associate active links with user profile based on user preferences, selections, search, match, subscriptions, subscribers, connections, ranks, privacy settings, user & connected users one or more subscriptions of publishers, user activities, actions, events, transactions, location, interest, behavior, user profile, user data, suggested lists, message or publication content specific active links and share selective user profile and user data with said one or more applications, services, web sites, networks, widgets, groups, networks based on privacy settings and preferences. It will enhance user base of publishers and service providers and facilitating users to automatically subscribe preferred one or more 3^{rd} parties' applications, services, web sites, networks, widgets, objects, groups, networks without repetitive registrations with said service & application providers in an integrated and unified manner.

Yet another important objective of the present invention is to provide zero click or auto user registration with the system, web site, application, devices, groups, networks, services, wherein system automatically generates identity for un-registered user including public user, guest user, unlogged user when visit first time or later without registration to web site, try to access applications & services, access system from devices and said auto generated identity for unregistered user including GUID, unique identities, temp user id and/or password, code, image, URL or links, any other type of unique identities enables user to auto register and allowing to access with the system, web site, application, devices, groups, networks, services. User can later fill detail user profile including user name, user identities (ID) & password, gender, birth date or age, interest, location, language, privacy settings, preferences, connections, subscriptions & subscribers. User can log-in with the system, web site, application, devices, groups, networks, services, widgets, objects by entering or selecting said auto generated or assigned unique user identify.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards providing users with dynamically publishing, communication, searching, sharing and subscribing system. Mechanisms of the invention may enable user to publish wide varieties of contents in unified, integrated and customize manner. Publisher can publish one or more publishing types or publishing service specific contents including different types of messages, user's updated status, news, micro blogging, notifications, search results, deals, questions & answers, share contents including text, video, audio, images, photos, files, applications, objects, documents, URL and any digital contents. User can subscribe other user's one or more publication based on searching, matching, selecting, connections, invitations, preferences, privacy settings. A server may receives, stores, indexes and process each said published contents from each registered publisher user and present to target one or more subscribers, selected, matched and connected users.

Moreover, the present invention makes use of the following terms, definitions, acronyms, and abbreviations for describing the invention.

Dynamic publishing types: Publisher can search, select and switch one or more dynamic publishing types for publishing & sharing contents and dynamically use publishing type specific input system & application features for drafting, editing, posting and managing contents. Publisher can add new and customize existing publishing types and managing publishing type(s) specific subscribers, subscriptions, connections, lists & groups of subscribers, subscriptions & connections, publications, contents, active links & associate objects, object(s) data, menus, customization settings, privacy settings, conditions, metadata, templates, advertisements, payment information, preferences and shared user profile & user data.

Dynamic publishing type specific dynamic input system: System presents selected dynamic publishing type or publishing service specific input system to publisher for drafting, editing, viewing, applying privacy settings, attaching one or more metadata and active links and posting or sending said publications or shared contents to one or more subscribed, connected, selected & matched users.

Dynamic publishing type specific application features: System presents selected dynamic publishing type or publishing service specific one or more application features to publisher for managing publishing type specific publications and shared contents.

Dynamic publishing type specific presentation system: System presents selected dynamic publishing type or publishing service specific, received or send contents specific and categories specific presentation system to user with dynamic application features for managing, viewing, editing, organizing, filtering, sorting, sharing, processing contents and communicating, collaborating, participating, sharing, responding, transacting with sender or publisher or 3^{rd} parties applications, services, networks and devices.

Dynamic publishing specific active links: Publisher can search, match, and select one or more active links with each publications, shared contents & messages and post to one or more subscribers, selected, connected or matched users of network. Subscriber or receiver users can access said one or more active links.

Dynamic posting: Publisher can dynamically publish or share each content with one or more selected subscribers, connected or matched users based on privacy settings.

Dynamic subscriptions: Users are enabled to dynamically and automatically install, subscribe to or presenting lists for user selections of one or more applications, services, web sites, networks, widgets, groups, networks and attach associate active links with user profile based on user preferences, selections, search, match, subscriptions, subscribers, connections, ranks, privacy settings, user & connected users one or more subscriptions of publishers, user activities, actions, events, transactions, location, interest, behavior, user profile, user data, suggested lists, message or publication content specific active links and share selective user profile and user data with said one or more applications, services, web sites, networks, widgets, objects, groups, networks based on privacy settings and preferences.

Dynamic publishing services: Publisher can register one or more publishing services with service profile for providing services to subscribers. Services are searchable and allowed other users to subscribe said services based on associate privacy settings. Each service profile comprising publishing type, categories, name, descriptions, associate metadata, active links and related objects, applications, services, privacy settings, conditions & data. Publisher can integrate with and provide publishing services from 3^{rd} parties' external domains, applications, services, networks, devices and web sites. Subscriber of publishing services can access services from 3^{rd} parties' external domains, applications, services, networks, devices and web sites.

Publisher specific global active links and associate objects & data for other services, applications, groups, networks, web sites features or web parts, objects and multimedia contents: Publisher can publish other services, applications, objects, multimedia contents, widgets, web parts, web page, web site features, social networks, groups and allow user of network to dynamically, automatically and manually search, select, subscribe, install, attach active links of said one or more applications, services, web sites, networks, widgets, groups, networks with user profile or other prominent places of user web pages based on user preferences, selections, search, match, subscriptions, subscribers, connections, ranks, privacy settings, user & connected users one or more subscriptions of publishers, user activities, actions, events, transactions, location, interest, behavior, user profile, user data, suggested lists, message or publication content specific active links and receive shared selective user profile and user data with said one or more applications, services, web sites, networks, widgets, objects, groups, networks based on user privacy settings and preferences.

Dynamic publishing contents & sources search engine: Central server unit receives, stores, indexes and processes each published contents with active links & data of each publisher and publisher specific each global active links, active link associate objects & data and making them searchable for other users of network based on privacy settings and preferences. System provides search engine to users for searching said published contents, search sources or publishers and search sources or publishers based on at least part of published contents as per one or more search criteria.

Step by Step

In one embodiment present invention provides method for dynamically publishing and subscribing in a network(s) environment comprising:
registering user with profile and enabled user to act as publisher and/or subscriber;
storing each registered user's subscribers, subscriptions, connections, privacy settings & preferences, subscribed and published one or more publications, contents, active links and associate objects & data;
allowing user to subscribe one or more publishers and/or one or more publication types of one or more publishers of network;
allowing publisher to dynamically publishing publications based on publishing type selections 4001 and publisher specific global & default active links and associate objects & data 4025 & 6010;
dynamically presenting publishing type specific publishing input system, active links 4002 and application features for drafting & managing publications 4004;
allowing publisher to dynamically publishing each publication with or without attaching active links to subscribers and connected users 4003; and
dynamically presenting said published publication(s) 4005 with publishing type specific application features 4025 to target subscribers 4018 and connected users 4020 and/or auto installs, subscribe, attach, presents & upgrade publisher specific one or more global & default active links and associate objects & data with subscriber's profile page 4050.

In one embodiment subscriber of publisher can dynamically access publishing type specific publications based on dynamic publishing type specific presentation and application features and enables subscribers to dynamically access publisher specific global & default active links and associate objects & data.

System allows publishers to dynamically manage, add, edit, remove, upload, upgrade, search, select one or more publishing types, publishing type associate dynamic input system, active links and associate objects, applications, services, widgets, multimedia data, Web pages, profile objects, networks, groups and like, publishing type specific dynamic application features, publishing type specific subscribers, subscriptions, connections, privacy settings, customization settings, preferences, prospective publication contents & templates, metadata, shared profile & publisher data, rules & conditions, advertisement.

System allows publishers to dynamically manage, add, edit, remove, upload, upgrade, search, select publisher specific one or more global & default active links and associate objects & data including one or more applications, services, widgets, multimedia data, Web pages, profile objects, networks, groups, preferences, privacy settings, metadata, templates, conditions & rules, customization settings.

Subscribers are enabled to access each publication, take one or more actions on publications, view metadata, provide comments and rank, search, sort, categories, filter one or more publications and access publication associate active links, wherein said active links enables user to communicate, collaborate, search, share, give & receive response, create groups, social network, buy and sell, make payment & transactions, participate with publisher(s), 3^{rd} parties service providers and other users of network.

Publisher or sender or source can publish messages, multimedia data, contents, active links and active link associate one or more objects, object associate data, privacy settings & metadata, wherein said active links enables subscribers and publishers to e-commerce, deals, transactions, marketing, advertisement, communication, collaboration, search, share, take one or more actions, games, provide & consume services including entertainment, travel, finance, sports, education, news, blog, maps, social networks, groups and other online services in a unified and integrated manner.

System is configured to auto install and auto subscribe one or more active links of one or more publishers or sources to profile of subscriber or user's publisher page, wherein said one or more attached active links enables user to communicate, collaborate, answer, share, search, workflow, take one or more actions, transact, e-commerce, create social networks and participate with publisher or source, wherein said auto installing and auto subscribing one or more active links of one or more publishers or sources based on user subscriptions with publisher(s), user and connected users' profile(s), data, message(s) & message(s) associate active links and installed applications & active links, user connections, user actions, activities, interest, behavior, transactions, events, preferences, privacy settings and auto match making.

User can install, attach & subscribe one or more active links of one or more publishers or sources with user profile or user's publisher page based on search, match, selection, bookmarks, suggestions, connections, preferences, privacy settings, message(s) & message(s) associate one or more active links, user profile & user data, user activities, actions, events & transactions, wherein said one or more attached active links enables user to communicate, collaborate, answer, share, search, workflow, take one or more actions, transact, e-commerce, create social networks and participate with publisher or source.

User can sort, filter, categories, groups, order, provide rank & comments, take one or more actions, apply privacy settings & customization settings to one or more active links, share profile, user data with active link associate objects and share active link associate object(s) data with publisher of active link(s).

Active link comprises of one or more applications, services, objects, shared objects, web parts, widgets, micro web sites, multi AI agents, multimedia data & contents, people, networks, groups, links or URLs, ID, User Profiles, profile objects, pages, attachments, informational links including advertisements, deals, lists, messages, web URL, multimedia data and shared workspaces for collaboration from networks and/or from external domains, applications, networks, services and devices with one or more associate metadata including name & ID, categories, keywords, date & time, description, help, properties, source, size, namespace & URL, payment information, privacy settings, customization information.

User is enabled to subscribe to any preferred users and send or share each message or publishing resources to each subscribers and/or publish in public, wherein message or publishing resource subscription based on selections, send request or invite others, connections, contacts, search people, find friends from contacts, search sources from message(s) associate source(s), search subscribers & subscriptions of each public user, one or two way match making preferences, rules, conditions, categories, taxonomy wise directories, lists, auto match based on preferences, profile, user data and user activities, actions, events & transactions.

In another embodiment subscription based on selections, send request or invite others, connections, contacts, search people, find friends from contacts, search sources from message(s) associate source(s), search subscribers & subscriptions of each public user, one or two way match making preferences, rules, conditions, categories, taxonomy wise directories & lists, auto match making based on preferences, profile, user data and user activities, actions, events & transactions.

User can register one or more publishing service and publishing type based on utilizing publishing type templates and associate active links, objects & data.

Publisher user can dynamically integrate publishing type(s) specific publishing services with and provide services from 3^{rd} parties' domains, web sites, applications, services, networks, devices and services.

Subscriber user can integrate subscribed publication services with and receive publication services from 3^{rd} parties' domains, web sites, applications, services, networks, devices and services.

3^{rd} parties domains, web sites, applications, services, networks, devices and services are enabled to integrate selective or filtered publishing services or publishing types and access user profile, publishing service profiles, publishing service or publishing type associate applications, objects, multimedia data, metadata, settings, subscriber & subscriptions, shared contents and allow other users to subscribe said one or more integrated publishing services.

Users are configured to search, select and/or subscribe one or more publishers and/or service associate contents based on one or more criteria, wherein search result comprises of presenting a list of searched publishers with accessible metadata & parameters including publisher's profile link, publication or publishing type profile link, publisher name, publication service name, description, rank, grade, namespace, hits statistics, payment terms, metadata, date & time, language, location, domain, associated taxonomy or categories, keywords, subscribers' reviews & comments, service type including public, private, verified, paid, availability status including online, offline, away, timings and service usage details.

Publisher can publish other services of publishers and associate active links, active links associate objects & objects associate data with one or more publishing services and allow to auto install, subscribe, access & attach said other services and associate active links, active links associate objects & objects associate data to subscriber user's profile or other prominent places, wherein user can manually search, filter, bookmark, select, share, sort, install, attach, detach, remove, categories and subscribe said one or more publishers specific one or more other services and associate one or more global active links, active links associate objects & objects associate data.

In another embodiment present invention provides method for dynamically presenting publisher specific active links and associate objects & data comprising:
allow user to subscribe one or more publishers, publishing types, publishing services, and publications of publisher(s);
dynamically present, install, subscribe, attach & update one or more publishers, publishing types, publishing services, and publications of publisher(s) specific one or more global active links and associate objects & data with subscriptions of said one or more publishers, publishing types, publishing services, and publications of publisher(s) to user's profile or user's publications presentation page; and
allow user to access, select, search, filter, bookmark, share, add, attach, detach, remove, sort, order, install, subscribe, log, monitor & record actions, apply privacy settings, provide comments & ranks, update and categories said subscribed one or more publishers, publishing types, publishing services, and publications of publisher(s) specific active links and associate objects & data, wherein said one or more active links enables user to communicate, collaborate, answer, share, search, workflow, take one or more actions, transact, e-commerce, create social networks and participate with publisher or source.

Active link comprising one or more applications, services, objects, shared objects, web parts, widgets, micro web sites, multi AI agents, multimedia data & contents, people, networks, groups, links or URLs, ID, User Profiles, profile objects, pages, attachments, informational links including advertisements, deals, lists, messages, web URL, multimedia data and shared workspaces for collaboration from networks and/or from external domains, applications, networks, services and devices with one or more associate metadata including name & ID, categories, keywords, date & time, description, help, properties, source, size, namespace & URL, payment information, privacy settings, customization information.

Users are enable to dynamically and automatically install, subscribe to or presenting lists for user selections of one or more applications, services, web sites, networks, widgets, groups, networks and attach associate active links with user profile based on user preferences, selections, search, match, subscriptions, subscribers, connections, ranks, privacy settings, user & connected users one or more subscriptions of publishers, user activities, actions, events, transactions, location, interest, behavior, user profile, user data, suggested lists, message or publication content specific active links and share selective user profile and user data with said one or more applications, services, web sites, networks, widgets, objects, groups, networks based on privacy settings and preferences.

In another embodiment present invention provides method for auto & zero click user registration comprising:
auto generating un-registered user's unique identity when un-registered user visit first time or later without registration to web site, try to access applications, services, widgets & objects, access system from devices; and
registering user with and allow to access & log-in system, web site, application, devices, groups, networks, services based on said auto generated identity.

User can log-in with the system, web site, application, devices, groups, networks, services, widgets, objects by entering or selecting said auto generated or assigned unique user identify.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be employed in a system implementing the invention;

FIG. 3 shows one embodiment of a network device that may be employed in a system implementing the invention;

FIG. 4 illustrates example of graphical user interface (GUI) for managing dynamic publishing, subscribing and presenting shared contents;

FIG. 5 illustrates example of graphical user interface (GUI) for selecting various publishing types and managing publishing types, publisher specific global active links and associate objects & data;

FIG. 6 illustrates example of graphical user interface (GUI) for selecting various publishing types and managing publishing types, publisher specific global active links and associate objects & data;

FIG. 7 illustrates example of graphical user interface (GUI) for the central server search engine for searching publishing sources, publishing services, publishing types and associate active links, published contents and subscribers.

### DETAILED DESCRIPTION OF THE DRAWINGS

Illustrative Operating Environment

Website Architecture

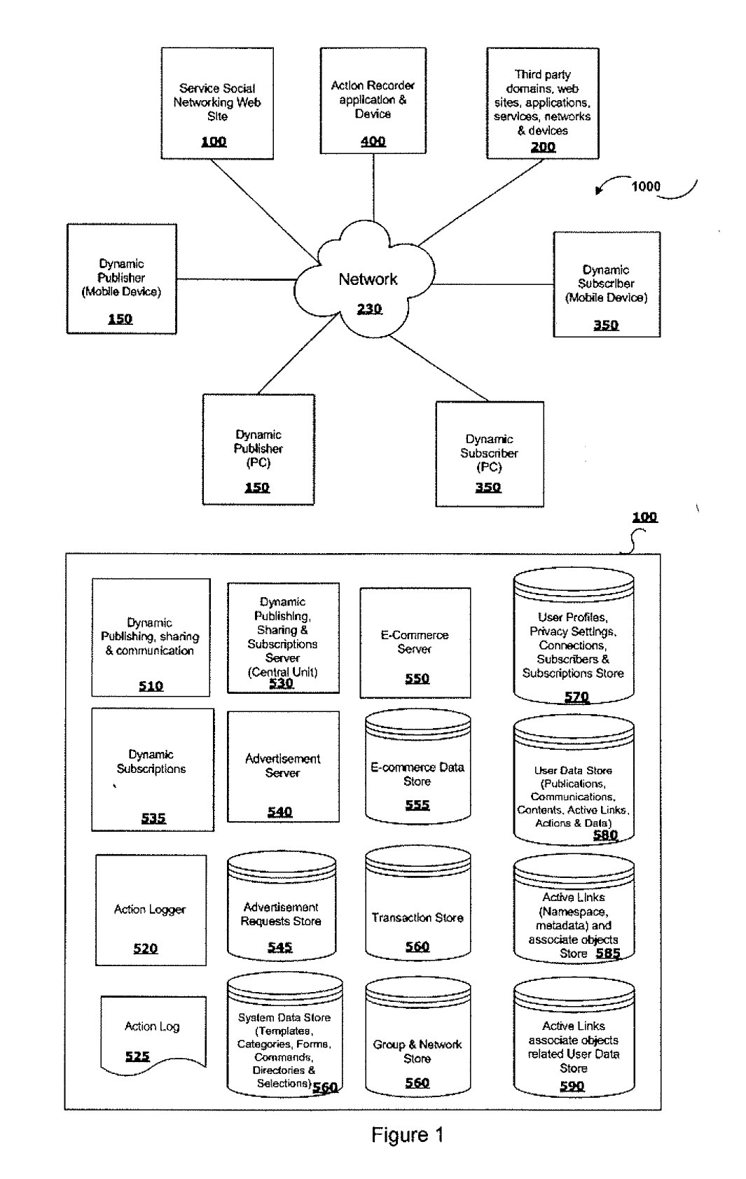

FIG. 1 is a high level block diagram illustrating a system environment suitable for operation of a social networking website 100. The system environment comprises one or more client devices 150 and 350, one or more third-party third party domains, web sites, applications, services, networks & devices 200, a social networking website 100, and a network 230. In alternative configurations, different and/or additional modules can be included in the system.

The client devices 150 and 350 comprise one or more computing devices that can receive member input and can transmit and receive data via the network 230. For example, the client devices 150 and 350 may be desktop computers, laptop computers, smart phones, personal digital assistants (PDAs), or any other device including computing functionality and data communication capabilities. The client devices 150 and 350 are configured to communicate via network 230, which may comprise any combination of local area and/or wide area networks, using both wired and wireless communication systems. As described above, the third party domains, web sites, applications, services, networks & devices 200 and the action recorder-150 are coupled to the network 230 for communicating messages to the social networking website 100 about the members' actions off the website 100.

The social networking website 100 provides dynamic publishing and subscribing based social network to users of network for that social networking website 100 registering each members and receives and stores each users profiles, privacy settings, preferences, subscribers & subscriptions, connections with other users of network to user profile store 570, allow user 350 to register one or more publishing services with service profile(s) including service descriptions, service related active links and associate objects, applications, application features, services, multimedia data, privacy settings, preferences and metadata and allow users 150 to search, select and subscribe other users' publishing services, allow publishers 150 to mange registered services and provide publications, shared contents and communication with subscriber(s) including tasks & workflow fulfillment, sharing resources & any types of user generated contents, support services, knowledge services, computing resource sharing, participations, communications, searching, collaboration, e-commerce and any user contributed works, tasks and efforts, allow subscribers 350 to mange subscriptions including accessing, using, unsubscribing publishing services, searching and subscribing other services, send request to publishers for subscribing publishing services, access services from external domains, refereeing service to other connected users of the social network. The social networking website 100 allow user to take one or more actions on said publishing services, publications or shared contents, communications and associate active links and monitor, track, store, filter and records said one or more user actions in user data store 580.

The social networking website 100 comprises a computing system that allows members to communicate or otherwise interact with each other and access content as described herein. The social networking website 100 stores member profiles that describe the members of a social network, including biographic, demographic, and other types of descriptive information, such as work experience, educational history, hobbies or preferences, location, and the like. The website 100 further stores data describing one or more relationships between different members. The relationship information may indicate members who have similar or common work experience, group memberships, hobbies, or educational history. Additionally, the social networking website 100 includes member-defined relationships between different members, allowing members to specify their relationships with other members. For example, these member defined relationships allows members to generate relationships with other members that parallel the members' real-life relationships, such as friends, co-workers, partners, and so forth. Members may select from predefined types of relationships, or define their own relationship types as needed.

FIGS. 1-100 is an example block diagram of a social networking website 100. The social networking website 100 includes a web server 530, an action logger 520, an action log 520, a dynamic publications 510, a dynamic subscriptions 535, an ad server 540, a database of ad requests 545, an e-commerce server 550, e-commerce data store 550, a user profile including privacy settings, preferences, connections and publishing service profile(s), subscribers & subscriptions store 570, a group & network store 560, each active link related namespace, properties, metadata & associate objects store 585, each active link associate object or application related user data store 590, a transaction store 560, user data store including publications, shared contents, communications, user contents, active links, actions data store 580 and system data store including publishing service profile templates and service profile specific active links, associate objects, applications, services, objects, privacy settings, customization settings, metadata, lists, categories, taxonomies, keywords, rules forms, commands, directories & various selections 560. In other embodiments, the social networking website 100 may include additional, fewer, or different modules for various applications.

The web server 530 links the social networking website 100 via the network 230 to one or more client devices 150 and 350, as well as to one or more third party websites 200. The web server 530 may include a mail server or other messaging functionality for receiving and routing messages between the social networking website 100 and the client devices 150 and 350 or third party websites 200. The messages can be instant messages, queued messages (e.g., email), text and SMS messages, or any other suitable messaging technique.

The action logger 520 is capable of receiving communications from the web server 530 about member actions on and/or off the social networking website 100. The received actions can occur within the social networking website 100 as well on other websites, via an application programming interface exposed by the social networking website 100. In one embodiment, the social networking website 100 maintains the action log as a database of entries. When an action is taken on and/or off the social networking website 100, an entry for that action is generated and stored by the action logger 520. Examples of user actions within the social networking website 100 include registering publishing services, subscribing services, searching, sharing resources, installing applications, creating groups, providing responses, posting requests, receiving related responses, attaching active links, take one or more actions on each request, related response and active links including purchase or sell products, book tickets, likes one or more brands, joining a group, communication & sharing with other users. Examples of user actions outside of the social networking website 100 include purchasing or reviewing a product or service using an online marketplace hosted by a third-party website 140, auto recorded, auto detected, auto sensed, auto selected or extracted from user's service life stream, auto extracted from video or audio or images, auto identified, auto determined, auto generated and auto posted one or more publishing contents from one or more applications, services, networks and devices based on monitoring, tracking and recording of user actions, events, current location, transactions & activities by action recorder applications & devices 400.

The action logger 520 includes data describing the member performing the action, the date & time the action occurred, an identifier for the member who performed the action, an identifier for the member to whom the action was directed, an identifier for the categories of action performed, an identifier for an object acted on by the action (e.g., an application), content associated with the action, identifying one or more objects associate with actions, dynamically identifying and associating one or more active links & applications or application features with action, who-what-where-when-how-where about the action occurred and/or other data describing the action. The action logger 520 can communicate with the all active links, objects, applications, services, groups, networks, data & content stores of network related to actions and/or user related to action. The action logger 525 can organize the stored action data according to an action identifier which uniquely identifies each stored action.

Service subscriber user 350 can receiving subscribed or shared contents and view selected publishing type specific contents 535 from one or more publishers 150 via social networking website 100 where said contents are stores at 580. Social networking website 100 sends said subscribed publications 510 to one or more subscribers 150.

Mobile Device

FIG. 1 shows components of one embodiment of an environment in which the invention may be practiced. Not all the components may be required to practice the invention, and variations in the arrangement and type of the components may be made without departing from the spirit or scope of the invention. As shown, system 1000 of FIG. 1 includes a client device 150 and 350, in particular mobile device and personal computer. The system also includes social networking website 100, network 230, central server 530 and publisher and subscriber) client devices 150 & 350.

A variety of client devices may be employed in accordance with the invention. The client devices may include mobile devices, digital home clients such as personal computers and media centers, and other client devices. Generally, mobile device 150 may include virtually any portable computing device capable of receiving and sending a message over a network, such as network 230, or the like. Mobile device 150 may also be described generally as a client device that is configured to be portable. Mobile device 150 may have the capability of connecting to a network using wireless technology, wired technology, or a combination of both wired and wireless technologies. Thus, mobile device 150 may include virtually any portable computing device capable of connecting to another computing device and receiving information. Such devices include portable devices such as cellular telephones, smart phones, display pagers, radio frequency (RF) devices, infrared (IR) devices, Personal Digital Assistants (PDAs), handheld computers, sensors, laptop computers, wearable computers, tablet computers, integrated devices combining one or more of the preceding devices, and the like. As such, mobile device 150 typically ranges widely in terms of capabilities and features. For example, a cell phone may have a numeric keypad and a few lines of monochrome LCD display on which only text may be displayed. In another example, another cell phone or web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, video, multimedia, and the like, employing virtually any web based language or protocol, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile device 150 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, mobile device 150 may uniquely identify itself through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to central server 530 or other computing devices.

Mobile device 150 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as central server 530, another web server, or the like. However, the present invention is not limited to these message protocols, and virtually any other message protocol may be employed.

Mobile device 150 may be further configured to enable a user to participate in communications sessions, such as IM sessions. As such, mobile device 150 may include a client application that is configured to manage various actions on behalf of the client device. For example, the client application may enable a user to interact with the browser application, email application, IM applications, SMS application, and the like. Generally, instant messaging provides ability for at least two computing devices to exchange messages in real time.

Mobile device 150 may further be configured to include a client application that enables the end-user to log into an end-user account that may be managed by a network application. Such an end-user account, for example, may be configured to enable the end-user to receive emails, send/receive IM messages, SMS messages, and access selected web pages, maintain a digital wallet, or the like.

Network 230 is configured to couple mobile device 150 & Personal Computer 150, as well as other client devices not illustrated, and their components, with other network devices, such as central server 530, and the like. Network 230 is configured to couple responder client devices 150 and 350 with central server 530 of the social networking site 100.

Though for illustrative purposes network 230 are shown, in various environments employing the present invention, same network, different networks, or different networks including a combination of overlapping components and distinct components. The discussion herein that describes network 230 may therefore be applicable to describe network.

Network 230 may include any of a variety of wired or wireless sub-networks that may further overlay stand-alone ad-hoc networks, and the like, to provide an infrastructure-oriented connection for mobile device 150. Such sub-networks may include mesh networks, Wireless LAN (WLAN) networks, cellular networks, and the like. Additionally, network 230 may connect to mobile devices with a wired connection, such as cable, phone lines, Ethernet wires, and the like. Network 230 may include wide area networks, such as the Internet. The invention may be used either generally with networks, specifically with wireless networks, or with various combinations of wireless and wired networks.

Network 230 may further include an autonomous system of terminals, gateways, routers, and the like connected by wireless radio links, and the like. These connectors may be configured to move freely and randomly and organize themselves arbitrarily, such that the topology of network 130 may change rapidly.

Network 230 may further employ a plurality of access technologies including 2nd (2G), 3rd G) generation radio access for cellular systems, WLAN, Wireless Router (WR) mesh, and the like. Access technologies such as 2G, 3G, and future access networks may enable wide area coverage for mobile devices, such as mobile device 150 with various degrees of mobility. For example, network 230 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, network 230 may include virtually any communication mechanism by which information may travel between mobile device 150 and another computing device, network, and the like.

Network 230 may further include or employ one or more network gateways (not shown) that serve as intermediaries between mobile device 150 and other network devices, such as central server 530. A network gateway may receive data from a device or network, transform the data, and forward the data to another device or network. A network gateway may perform a transformation in more than one direction. Transformation may, for example, include modifying protocols or communications mechanisms in order to facilitate communication between two devices or two networks, each of which may employ differing protocols. A WAP gateway is one type of network gateway. A WAP gateway may facilitate communication between a first device that uses the Wireless Application Protocol (WAP), and a second device. The second device may, for example, communicate using the HyperText Transfer Protocol (HTTP). An SMS gateway is a network gateway that facilitates communication between a device using the Short Message Service (SMS) protocol and another device, such as one using HTTP. A WAP and SMS gateway combines the features of a WAP gateway and an SMS gateway.

In one embodiment, network 230 may include one or more components of an instant messaging service that operates to facilitate communication of instant messaging between mobile device 150 and central server 530 of the social network web site 100.

FIG. 1 shows mobile device 150 communicating with central server 530 of the social network web site 100, and central server 530 communicating with subscribers 350. FIG. 1 also shows central server 530 communicating with subscriber client devices 350. Each of these communications may employ a direct connection, or one or more networks, or a combination thereof. For illustrative purposes, FIG. 1 does not show communication between central server 530 and subscribers employing network 230, however environments that include this communication may be employed with the present invention. In particular, central server 530 and subscribers may employ any one or more of direct communication, a local area network, or a wide area network, such as network 230.

A network enabling any one or more of the above communications may employ any form of computer readable media for communicating information from one electronic device to another. Also, the network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the network includes any communication method by which information may travel between central server 530, publishers 150 and subscribers' client devices 350, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Publisher and subscribe clients 150 & 350 are computing devices that may be employed by a user, referred to as a user, for publishing and subscribing contents. A variety of client devices may be employed in accordance with the invention. Client devices may include mobile devices, digital home clients such as personal computers and media centers, and other client devices. Generally, responder clients may include virtually any computing device, portable or non-portable, capable of receiving and sending a message over a network, such as network 230, or the like. Clients may include devices such as mobile device 150 (mobile device) or 150 (PC) described herein. Though FIG. 1 illustrates only two clients 150 (mobile device) or 150 (PC), it is envisioned that the invention may be practiced in an environment that include a large community of publisher and/or subscriber clients. Thus, clients may number in the hundreds, thousands, hundreds of thousands, millions, or virtually any number.

Though FIG. 1 illustrates an embodiment of a system having each of network central server(s) 530 and publishers 150 and/or subscribers 350 as separate computing devices, the invention is not so limited. Software, hardware, or hardware-software combinations implementing any portion of these components may be combined with any other component on a single computing device, or arranged in a different manner among multiple computing devices. Some portion or all of the functionality of any component may be distributed or duplicated among multiple computing devices.

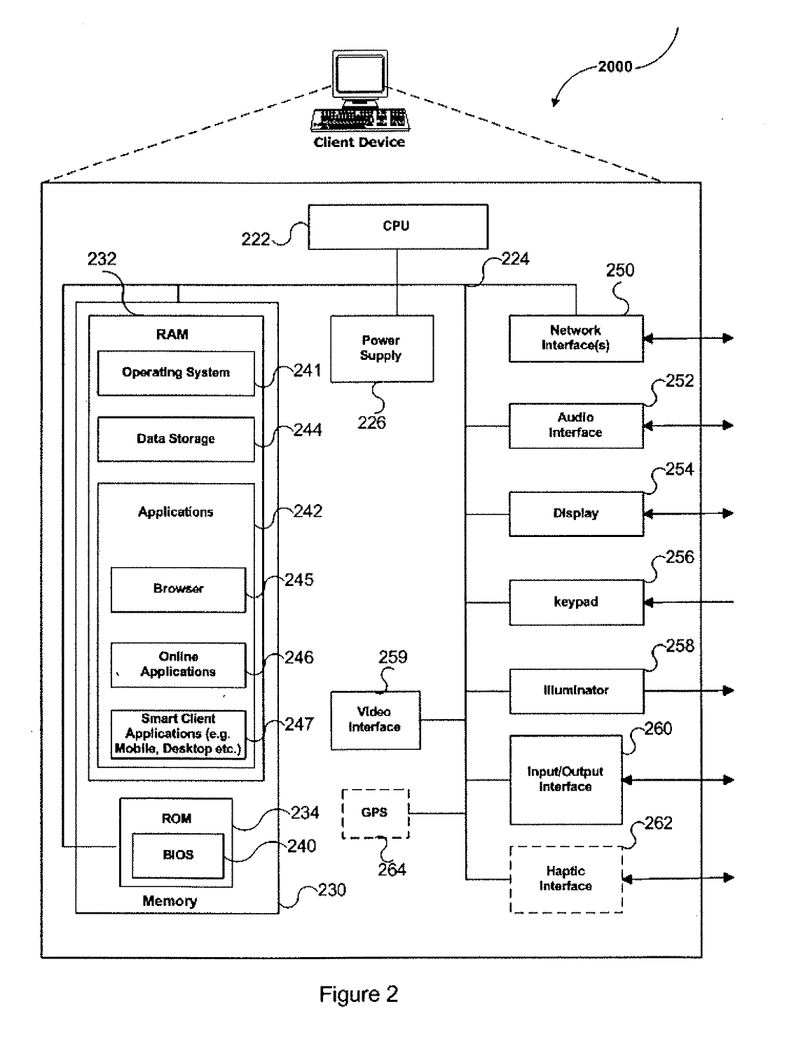

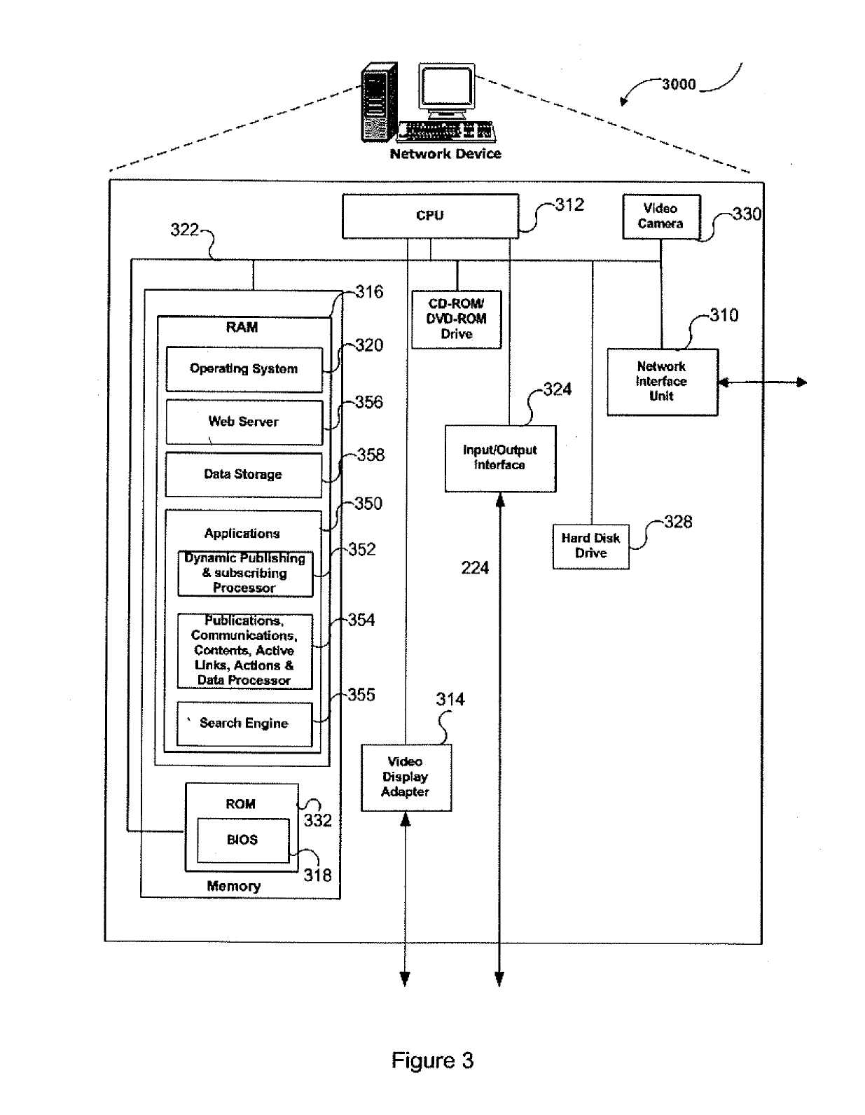

One embodiment of a network device that may be used to implement any one or more of central server 530 is described in more detail below in conjunction with FIG. 3. Briefly, however, such network devices may include any computing device capable of communicating with other network devices to enable network applications or web sites to process and respond to requests from client devices, such as mobile device 150 is described in more detail below in conjunction with FIG. 2. Devices that may operate as these network devices include personal computers desktop computers, multiprocessor systems, microprocessor-based or programmable consumer electronics, network PCs, servers, and the like, or any combination thereof.

FIG. 1 illustrates an embodiment in which mobile device 150 communicates with central server 530. A user of mobile device 150, referred to as an “publisher,” may employ mobile device 150 to send publication contents or share resources to central server 530. Central server 530 may receive and process the publication contents or share resources from mobile device 150. Central server 530 may select a set of subscribers' devices 350. A subscriber is a person who employs a subscriber device to receive publications or shared contents from publisher and respond to them. Central server 530 may employ identifiers or addresses of publisher, publisher devices, or both. It may, for example, employ a login name or email address of a publisher. It may employ an IP address, MIN, or other identifier of a publisher device. Central server 530 may employ any one or more of these identifiers or addressing mechanisms when communicating with a publisher or publishing device and subscriber or subscriber device. As used herein, unless the context clearly indicates otherwise, the term “publisher” or “subscriber” may be used to refer to a person, a publisher or subscriber device, or a combination of a person and a publisher or subscriber device.

Illustrative Client Device

FIG. 2 shows one embodiment of client device 2000 that may be included in a system implementing the invention. Client device 2000 may include many more or less components than those shown in FIG. 2. However, the components shown are sufficient to disclose an illustrative embodiment for practicing the present invention. Client device 2000 may represent, for example, publisher user client devices 150 (mobile device) and 150 (PC) and subscriber user client device 350 (mobile device) and 350 (PC) of FIG. 1.

As shown in the figure, client device 2000 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 2000 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 2000 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the optional haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may, through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® Operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store multimedia information and/or content for later publication, editing, or the like, as well as other information including address lists, contact lists, personal preferences, or the like. At least a portion of the content may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), content, and enable telecommunication with another user of another client device. Other examples of application programs include calendars, editors, email clients, IM applications, SMS applications, VoIP applications, contact managers, task managers, transcoders, database programs, word processing programs, security applications, spreadsheet programs, games, search programs, and so forth. Applications 242 may further include browser 245. Browser 245 may include virtually any of a variety of client applications configured to receive and/or provide communications of web pages, and other content over a network. Browser 245 typically provides for a graphical display of various web pages, including user interfaces provided, in part, by another computing device over the network. Browser 245 may include a variety of security features, and/or other plug-in applications, modules, applets, scripts, or the like, to enable display of animation, videos, playing of audio files, or the like. Browser 245 and applications 242 are configured to enable a user or publisher user and/or subscriber user to communicating with or prepare content for sending to central server 530 of the social networking web site 100 of FIG. 1. Moreover, through one or more of applications 242, the user or publisher user and/or subscriber user may send or receive content or messages or notifications.

Illustrative Network Device Environment

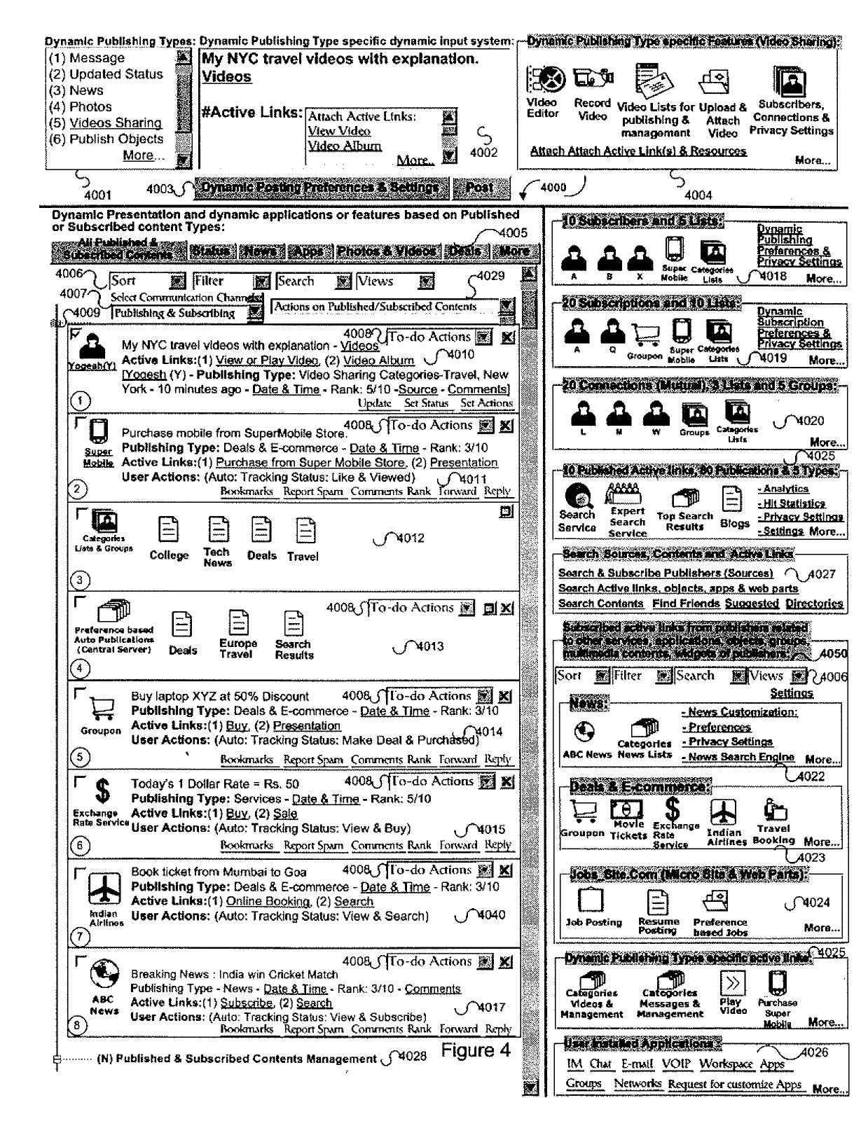

FIG. 3 shows one embodiment of a network device 3000, according to one embodiment of the invention. The embodiment of network device 3000 illustrated in FIG. 3 may be used to implement the dynamic publications & subscriptions' central server 530 or the ads server 540 of FIG. 1. Network device 3000 may include many more components than those shown. It may also have less than all of those shown. The components shown, however, are sufficient to disclose an illustrative embodiment for practicing the invention. One or more network devices, and the application programs integrated with the devices, may be used to implement the processes of the present invention, as illustrated in FIGS. 4-7 and discussed herein.

In any event, network device 3000 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 3000 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account managers, and so forth. More detailed discussions of some application programs are included herein.

Mass memory further includes web server 356, data stores 358, and applications 350. Applications 350 are shown to include dynamic publishing & subscribing Processor 352 and Publications, Communications, Contents, Active Links, Actions & Data Processor 354 and Search, Match & Route Engine, Applications & Services server 355. Web server 356 includes virtually any application configured to delivers Web pages and other content to browsers and other client applications via at least the HTTP protocol. However, web server 356 may also be configured to provide scripts, user interfaces, accounting interfaces, editors, security, or the like, to the client application. Moreover, web server 356 may employ a variety of other communication protocols, beyond HTTP. For example, web server 356 may be configured to manage email communication protocols, SMS protocols, IM protocols, or the like. Moreover web server 356 may employ a variety of scripts, applets, programs, or the like, to enable communications of content with a client application.

Data stores 358 may include any of a variety of storage mechanisms, configured to store, and otherwise managed content, applications, scripts, applets, or the like. As such, data stores 358 may be a database, a file structure, or the like. Data stores 358 may store the content into a category structure, such as folders, albums, graphs, trees, or the like, based on a user account, a web service, or the like. In one embodiment, data stores 358 may represent the Data Management services illustrated in FIG. 1, and described in more detail below in conjunction with FIG. 4.

Dynamic publishing and subscribing platform is described in more detail below in conjunction with FIG. 4. Briefly, however, Dynamic publishing and subscribing platform 352 includes a variety of components to provide web services to a user, including search tools, user interfaces, plug-and-play modules, or the like. Various embodiments of example user interface screens are described in more detail below.

In one embodiment, applications 352 may include a Dynamic Publishing & subscribing Processor 354. A Dynamic Publishing & subscribing Processor may include program logic that performs actions in response to receiving a publication or shared contents from publishers or connected users' client device. These actions may include determining a set of subscribers to solicit responses from, sending a publication or shared contents to the set of subscribers or connected or selected & matched users or other actions relating to processing publications or shared contents.

In one embodiment, applications 354 may include a Publications, Communications, Contents, Active Links, Actions and Data Processor 356. A Publications, Communications, Contents, Active Links, Actions & Data Processor may include program logic that performs actions relating to receiving and processing publications or shared contents and communications. These actions may include receiving and collecting publications or shared contents, associating advertising, applying validation, spam control, limits & settings, preparing a publications or shared contents to be sent to the subscribers or determined target users, or other actions relating to processing publications or shared contents. These actions are discussed in further detail herein. Though FIG. 3 illustrates a dynamic publishing & subscribing processor, the actions and logic of each component may be combined into a single component, divided into multiple components in a different manner, or distributed in a variety of ways across multiple network devices.

Generalized Operation

FIG. 4 illustrates an exemplary GUI 4000 for dynamically managing all types of dynamic publications, sharing, one or more subscribers of one or more publications, subscriptions of publications of publishers from connected, likeminded and matched sources, categories lists & groups of subscribers, subscriptions & connections, search and dynamically attached active links and associate objects with user profile from plurality of subscribed publishers for providing enhanced functionality including applications, services, web features, widgets, objects, multimedia data, web parts, portlets, micro sites, plug-n-play, groups, networks and like. User can act as Publisher(s) and/or Subscriber(s). Publisher User can publish plurality types of publications & contents by selecting dynamic publishing types 4001. Based on said dynamic publishing type 4001 selection, system dynamically presents dynamic publishing type specific applications, services, publication type specific features, objects, multimedia data, associate connections, subscribers, subscriptions, groups, networks, lists, privacy settings, preferences, customization settings, hit statistics & analytics, metadata management including categories, keywords, author, date & time, descriptions, payment information, help, source and like and other management functionalities 4004 for facilitating Publisher User to manage, edit, draft, attach active links (1310) with publication or posting publication specific contents. Based on said dynamic publishing type 4001 selection, system dynamically presents dynamic input system 4002 for drafting, preparing, editing, updating, testing, reviewing one or more types of publications including text, video, images, photos, documents, files, objects, applications, URLs, Web pages and any types of multimedia data. After drafting one or more publications, Publishing User can dynamically post, publish, advertise, send, update, synchronize and present said one or more publications to one or more users including connected users, subscribers, one or two way match making preferences based target users, all users of network (public), selected users, rules and conditions based target users with associated one or more privacy settings and metadata 4003.

User can manage subscribers, categories list of subscribers and each or all subscribers or publications & contents specific dynamic publishing preferences & privacy settings 4018. In one embodiment any user of network can subscribe to any other user of network for receiving any types of one or more public publications. 4018 displays all subscribers of publishing user with statistics including number of subscribers, lists, number of message send to each subscriber, number of views and like. User can click on each subscriber icon for accessing selected subscriber's profile(s), public user data, public publications, public subscribers & subscriptions, view profile, communicate & share, make transactions with permission and like. User including publishing user and subscribing user includes any entities including person, organization, company, college, experts, automated digital sources, web site, applications, services, networks, device, groups, sensors, database and like. User can manage one or more subscriptions of one or more publishers and each publishers and associate publications specific preferences and privacy settings 4019. User can search and subscribe plurality of publishers or sources of publications or contents by plurality of ways based on selections, send request or invite others for creating connections, user connections & contacts, searching people from network, find friends from contacts, search sources from message(s) associate source(s), search subscribers & subscriptions of each public user, one or two way match making preferences, rules & conditions, categories, taxonomy wise directories & lists, auto match making of publishers based on preferences, profile & user data and based on user activities, actions, events & transactions 4021. User can also search & subscribe 4021 published public active links associate objects from plurality of publishers or sources based on one or more criteria and install one or more said active links associate applications, services, objects, multimedia data, web parts, and widgets from plurality of publishers or sources. User can subscribe to any other users and other user can subscribe to user in one way or two ways (mutual). User can manage connections including friends, family, know people or entities, co-workers, classmates and like 4020 for publishing and subscribing each other.

Central unit receives and process including indexing, associating metadata, active links, advertisements and routing or sending or presenting said each posted publications of each user to each publication specific target users in network(s). Central unit dynamically presents 4009 each publications or shared contents of each publication types (categories publication type's specific tabs—4005) to receiving users. Each publication type specific publication contents present in different or customize ways and organize in different tabs or single tab and dynamically provide applications, services, objects, application features associate with each publication type in unified, integrated manner for facilitating user to manage, view, edit, process, re-share or forward, reply, organize, sort, filter, search, match, provide ranks & comments and take one or more actions.

User can 4006 sort (1340), filter (1350), search & match (1360) and take one or more actions 4029 (1330) on all or selected one or more publications including messages, contents, active links, publishers or sources, active links, objects, applications, services, multimedia data, groups and like.

Publisher can publish each publication or message with one or more related active links and Publisher can also publish or upgrade default of global publisher or publication type or publication specific one or more objects, applications, services, widgets, multimedia data, web parts, portlets and micro sites 4025 which are searchable to other users and/or auto installed to receiving or subscribing user's profile page 4050. So subscribing user not only subscribe publisher user's publication including messages, updated status, news, photos, video but also subscribe publishing user's default & global active links associate objects, web parts, services, applications, widgets, multimedia data, social networks, groups which enables receiving or subscribing user to communicate, collaborate, provide response(s), provide service(s) including news, blogs, workflow, social networking, groups, e-commerce transaction, search, share, job & resume, posting and participate with publishing user's activities. 4050 shows user subscribed publisher(s) specific global active links including dynamically subscribed other services, applications, groups, networks, widgets, objects, publications of publishers.

Publishing user can manage all publishing types' specific publications and publisher specific default & global active links and associate objects & data 4025. Publisher can view hit statistics & analytics including number of subscriber installed said active links and associate objects & data, number of subscriber views publications, number of published active links and associate objects & data, number of published publications and like. Publisher can apply privacy settings and other customization settings with one or more active links and associate objects & data and publications.

Various examples of various embodiments 4022, 4023, 4024 shows user's subscribed each publisher specific global & default one or more active links and associate objects and data. Example 4022 shows “News” category specific various applications, services & widgets, multimedia data, web parts, social networks, groups and associate data, privacy settings, customization settings, preferences and news search engine from news publishing type publishers which are subscribed by user or subscriber. Example 4023 shows “Deals & E-commerce” category specific various applications, services & widgets, multimedia data, web parts, social networks, groups and associate data, privacy settings, customization settings, preferences and products & services search engine from e-commerce publishing type publishers which are subscribed by user or subscriber. Example 4024 shows “Job_Site.Com” category specific various applications, services & widgets including job posting, resume posting & preference based jobs, multimedia data, web parts, social networks, groups and associate data, privacy settings, customization settings, preferences and jobs search engine from job or recruitment publishing type publishers which are subscribed by user or subscriber.

User can subscribe plurality publishing types of publishers and receives each subscribed types of publishing related publications and contents which are dynamically present to user as per publishing types 4005 and each publishing type associate default active links and associate objects & data 4025 are present to user, which provides all general features specific to said publishing type and facilitate user to manage, access, use, view, categories, organize, sort, filter, search, order, rank, bookmark, share, forward, reply, print, purchase, subscribe, remove, edit, provide comments & details, associate keywords, privacy settings & metadata, take one or more actions on said publishing type specific publication contents and like.

User can invoke active link associate objects & data by clicking on one or more active links, each active link associate one or more objects are invoked and presented in unified, integrated, customized, personalized manner. System can monitor, records, stores & log each user's each actions, activities, events, transactions associate with said active links and associate objects & data and present said log with analytics & hit statistics to user as well as publisher(s) of said active link(s) based on privacy settings and preferences.

User can 4006 categories, sort, share, bookmarks, drag-n-drop, search, filter, remove one or more said active links and associate objects and data. System can also organize and rank & order said categories active links based on number of times use, rank by user, mark as important, connections, transactions, and actions.

User can share selected user data and user profile with publishers, connected & selected users, 3^{rd} parties developers based on privacy settings & preferences.

User can install 4026 applications, active links, objects, multimedia contents and like with user profile from central unit, 3^{rd} parties developers, uploaded by user, shared by connected and like minded users and search, select and install from search engine & categories directories based on one or more criteria and preferences.

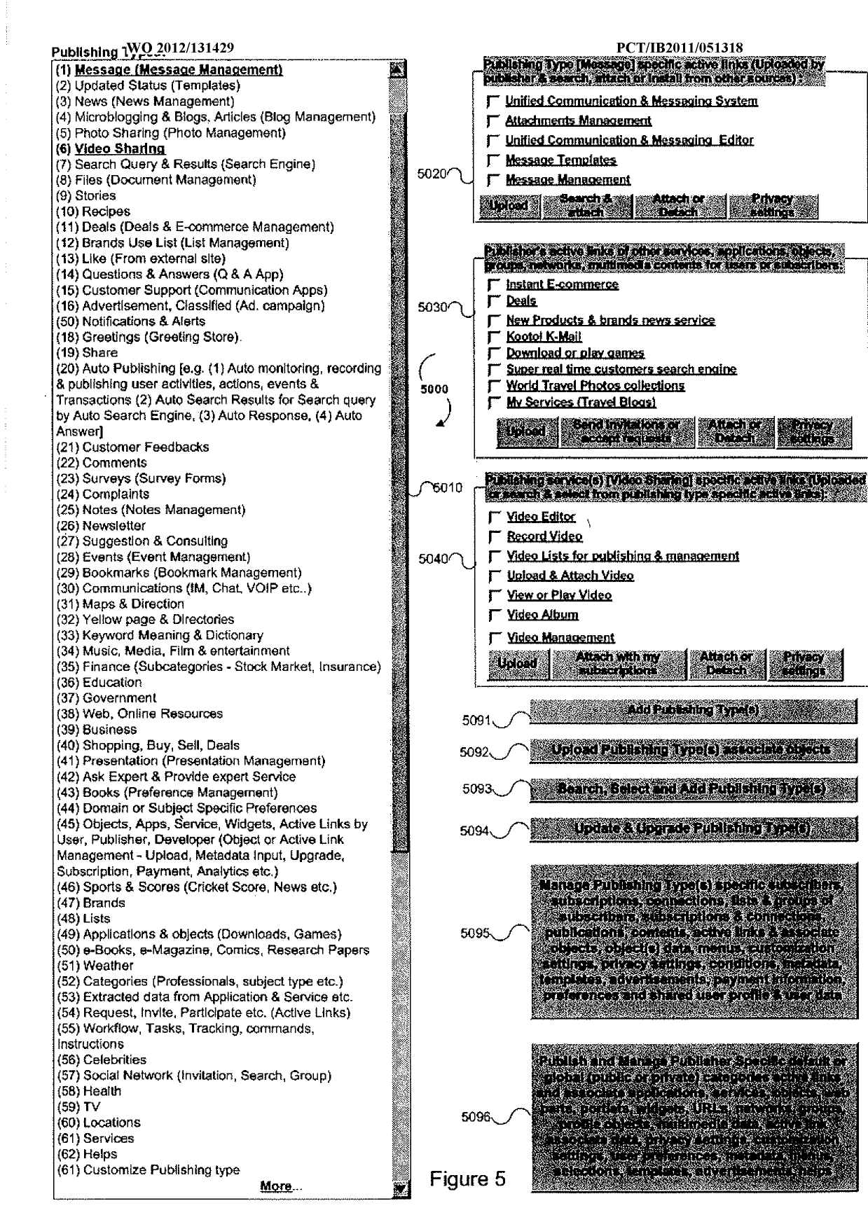

FIG. 5 illustrates an exemplary GUI 5000, which enables publishing user to select one or more Publishing types 5010 and provides management for managing each Publishing types including publishing user can adds 5091 one or more publishing type(s) which are displayed in dynamic publishing type list 4001 or 5010. User can upload 5092 publishing type(s) specific input system and associate list of active links, which are displayed to publisher user's dynamic input system area & active link attachment 4002 and upload or create & update one or more list of subscribers, subscriptions, connections, lists & groups, publications, contents, active links & associate objects, associate applications, services, application features, multimedia data, web page, widgets, web parts, portlets, plug-n-play, menus, shared user profile & data, customization settings, privacy settings, conditions, metadata, templates, advertisements, payment information and preferences which are displayed to publisher user's dynamic publishing type specific features area 4004.

Publisher user can manage 5096 and publish publisher, publication & publication type specific default or global (public or private) categories active links and associate applications, services, objects, web parts, portlets, widgets, URLs, networks, groups, profile objects, multimedia data, active link associate data, privacy settings, customization settings, user preferences, metadata, menus, selections, templates, advertisements, helps which are searchable and auto or manually installed or upgraded to subscriber user's profile page and displayed said active links and associate objects to subscribing or receiving user's profile area including default or global dynamic active links & associate objects from publishers area 4050. User can search, select and install or subscribe said one or more publisher, publication & publication type specific default or global (public or private) categories active links, associate objects & data or in one embodiment when user subscribe one or more publisher, said active links automatically or manually install or attached with subscriber user's profile page based on user privacy settings and preferences.

Publishing user can search, select and add one or more public publishing types 5093 and install all associate data, objects and settings based on one or more search criteria from search engine which are provided by other publishers, central unit and 3^{rd} parties' developers and service providers.

After installing public publishing types associate data, objects and settings, user can auto or manually upgrade and update said associate data, objects and settings 5094.

User can manage each Publishing Type(s) specific 5095 List of Subscribers, Subscriptions, Connections, Lists & Groups, Publications, Contents, Active Links & associate objects, menus, Shared user Profile & Data, customization settings, Privacy Settings, conditions, metadata, templates, advertisements, payment information and Preferences 5095, wherein management includes adding, updating, upgrading, ordering, sorting, categorizing, ranking, selecting, removing, publishing, attaching with publication, publication drafting and like.

5020 shows exemplary publishing type [Message] specific active links including uploaded by publisher and search & attach or install from other sources which can used by publisher or other publisher based on privacy settings for adding or registering new publishing services.

5030 shows publisher's active links of other services, applications, objects, groups, networks, multimedia contents for users for subscriptions and for existing subscribers as updates & upgrades based on privacy settings. User can send request for allow to subscribe other services, groups, networks, publications or allow to attach or install one or more other applications, objects, widgets, multimedia contents of publisher. Publisher can send invitation for subscribing or installing & attaching one or more said active links related to publisher's other services, applications, object, widgets, and multimedia contents.

5040 shows exemplary publishing service(s) [Video Sharing] specific active links including uploaded by publisher or search & select from publishing type specific active links and allow subscribers to attach or updates said one or more active links.

In one embodiment publisher can register one or more publishing services with service profiles, wherein said service profile includes service name, details, service related applications, objects, multimedia contents, privacy settings, customization settings, conditions, payment information, metadata and mange each service including service subscribers, connections, contents, publications. Users of the network can search, select and subscribe said publishing service and access publishing services and service associate applications including input system, communication & presentation system, application features, objects, multimedia contents, privacy settings, customization settings.

In one embodiment, a method for communication in a network(s) environment comprising:
allowing each user to subscribe to each other user for receiving each publication of sender or publisher;
receiving and storing one or more user profiles, preferences, publication subscribers, publication subscriptions, dynamic relationships & connections, selections and privacy settings for sending and receiving publication and communication at a central unit;
determining one or more target subscribers by a sender;
allowing the sender to send each publication to the one or more target subscribers via a central unit;
receiving each publication with or without associated with one or more active links from the sender or publisher at the central unit, wherein said active links enables subscribers to access active links, communicate, provide response(s) & service(s), workflow, e-commerce transaction, participate with sender's one or more activities;
storing, indexing and processing said each publication with or without auto attaching one or more active links at the central unit wherein said active links enables subscribers to communicate, provide response(s) & service(s), workflow, e-commerce transaction, participate with sender's one or more activities;
determining one or more target subscribers by the central unit based on one or more preferences and subscriptions;
sending a representation of the each publication to the one or more target subscribers by the central unit;
presenting each publication in chronological order based on the preferences and privacy settings, subscriptions of target subscriber by the central unit; and
receiving, storing, indexing, ranking and processing said each public publication, related responses, active links & user actions for making the searchable for users and allow to search & subscribe source of publication based on at least part of message content and one or more predetermined criteria.

In one embodiment, publisher or sender or source can publish publication including messages, multimedia data, contents, active links and active link associate one or more objects, object associate data, privacy settings & metadata, wherein said active links enables subscribers and publishers to e-commerce, deals, transactions, marketing, advertisement, communication, collaboration, search, share, take one or more actions, games, provide & consume services including entertainment, travel, finance, sports, education, news, blog, maps, social networks, groups and other online services in a unified and integrated manner.

In one embodiment, auto installing and auto subscribing one or more active links of one or more publishers or sources to profile of subscriber or user's publisher page, wherein said one or more attached active links enables user to communicate, collaborate, answer, share, search, workflow, take one or more actions, transact, e-commerce, create social networks and participate with publisher or source. Auto installing and auto subscribing one or more active links of one or more publishers or sources based on user subscriptions with publisher(s), user and connected users' profile(s), data, message(s) & message(s) associate active links and installed applications & active links, user connections, user actions, activities, interest, behavior, transactions, events, preferences, privacy settings and auto match making.

In an another embodiment, user can install, attach & subscribe one or more active links of one or more publishers or sources with user profile or user's publisher page based on search, match, selection, bookmarks, suggestions, connections, preferences, privacy settings, message(s) & message(s) associate one or more active links, user profile & user data, user activities, actions, events & transactions, wherein said one or more attached active links enables user to communicate, collaborate, answer, share, search, workflow, take one or more actions, transact, e-commerce, create social networks and participate with publisher or source.

User can sort, filter, categories, groups, order, provide rank & comments, take one or more actions, apply privacy settings & customization settings to one or more active links, share profile, user data with active link associate objects and share active link associate object(s) data with publisher of active link(s).

In an embodiment, Active link comprising one or more applications, services, objects, shared objects, web parts, widgets, micro web sites, multi AI agents, multimedia data & contents, people, networks, groups, links or URLs, ID, User Profiles, profile objects, pages, attachments, informational links including advertisements, deals, lists, messages, web URL, multimedia data and shared workspaces for collaboration from networks and/or from external domains, applications, networks, services and devices with one or more associate metadata including name & ID, categories, keywords, date & time, description, help, properties, source, size, namespace & URL, payment information, privacy settings, customization information.

In one embodiment, each user can subscribe to any preferred users and send or share each message or publishing resources to each subscribers and/or publish in public, wherein message or publishing resource subscription based on selections, send request or invite others, connections, contacts, search people, find friends from contacts, search sources from message(s) associate source(s), search subscribers & subscriptions of each public user, one or two way match making preferences, rules, conditions, categories, taxonomy wise directories, lists, auto match based on preferences, profile, user data and user activities, actions, events & transactions.

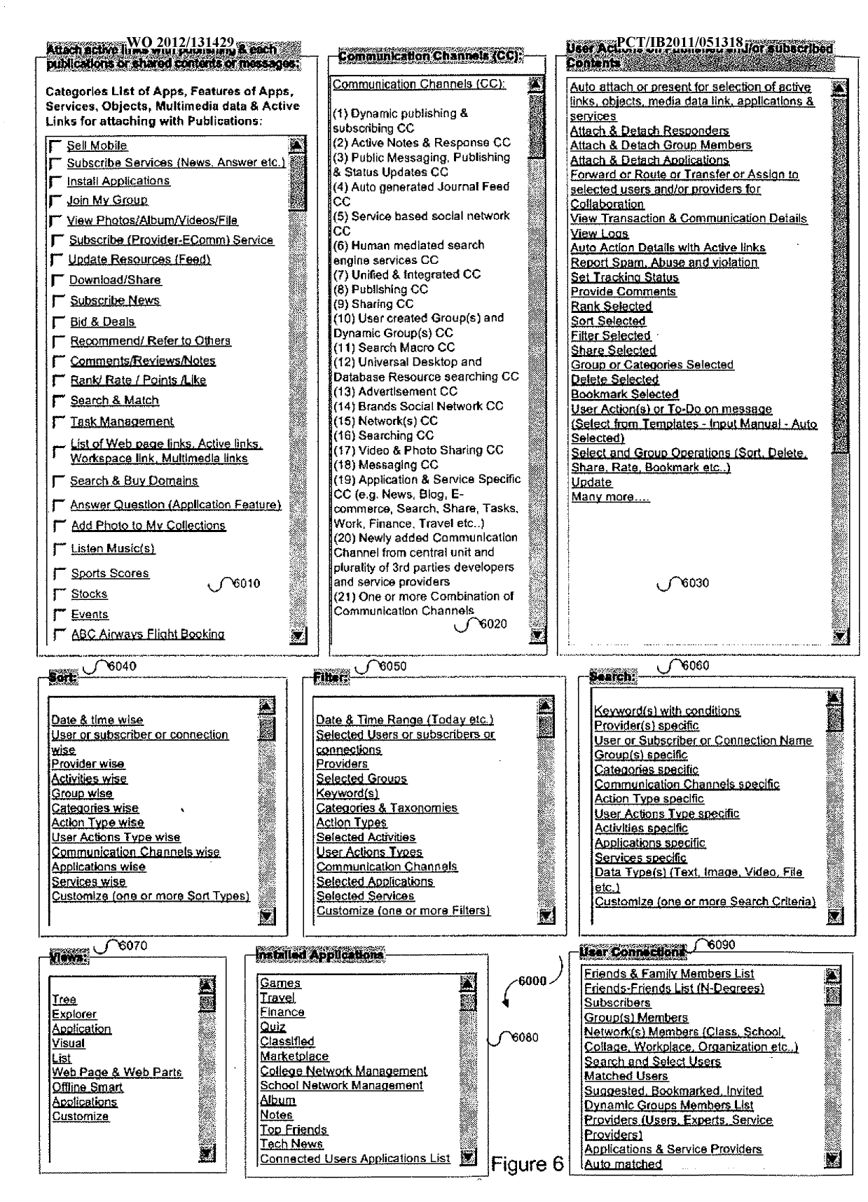

FIG. 6 illustrates an exemplary extended GUI 6000 for FIG. 4, wherein 6010 shows list of active links for attaching with each publishing and publications or shared contents or messages. Active links associates objects including applications, application features, services, objects, multimedia data, groups, networks, web page and said attached active links enables subscribers to communicate, collaborate, search, share, give & receive response, create groups, social network, buy and sell, make payment & transactions, participate with publisher(s), 3^{rd} parties service providers and other users of network.

FIG. 6 illustrates an exemplary GUI 6000 for user to select one or more communication channels 4007 & 6020 for presenting and managing all messages or communication data related to said selected one or more communication channels including:
(1) Dynamic publishing & subscribing Communication Channel, as describe in this invention.
(2) Active Notes & Response Communication Channel, where user can send active note with one or more active links to responders for receiving active note specific response with active links, wherein active links enables users to buy & sell products, make payment or transaction, communicate, collaborate, view presentation or media data, search, share, participate, workflow, refer to other users, e-commerce, make order, book tickets, view said advertisement, make deal, bidding for products and services, join group, install application, receives discount vouchers, fill survey forms, subscribe newsletters, bookmark product(s) or service(s), negotiate with advertiser, managing buying and selling process or activities as describe in U.S. patent application Ser. No. 13/001,785, titled: “A method and system for customize, contextual, dynamic & unified communication, zero click advertisement and prospective customers search engine”
(3) Public Messaging, Publishing & Status Updates Communication Channel, where user can subscriber & subscription of public message publication of any other users of network and search sources from public message content as describe in U.S. patent application Ser. No. 11/995,343, titled: “A method and system for communication, publishing, grouping, advertising, searching, sharing and dynamically providing a Journal Feed” and divisional U.S. patent application Ser. No. 13/045,489, titled: “A system and method for communication, publishing, searching and sharing”
   Examples:
   (1) Publisher User [A] publishes message: “I like Movie “ABC”, my movie details, story and rating . . . ” and have 3 subscribers Users [X], [Y] & [Z] and all subscriber users receives all updated messages from said publisher user [A]
   (2) Publisher User [A] publishes message: This is my tour photos—Download Link(s): Collections of Photos and have 3 subscribers Users [P], [Q] & [R] and all subscriber users receives all updated messages including said from said publisher user [A] and download and view said photos by clicking on said attached link.
   (3) Status updated by User [A]: “Currently I am in New York city mall” and all subscribed user receives each updated status from said user.
(4) Auto generated Journal Feed Communication Channel in which system monitors, records, stores & filters user activities or actions and auto generates journal items or messages based on said activities and attaching one or more active links & apps and send to connected users of user, where active links or apps enables a user to participate in the same activity as another user as describe in U.S. patent application Ser. No. 11/995,343, titled: “Method and system for communication, publishing, grouping, advertising, searching, sharing and dynamically providing a Journal Feed” and divisional U.S. patent application Ser. No. 12/973,370, titled: “A System and method for publishing, communication and real time searching”.
   Examples:
   (1) Auto generated action messages of User Y: (1) “User Y install application WWW” where User Y is source of message or action doer, install application is type of user action or activity and WWW is an application that user install. Central unit monitors user's “install application activity or action” and each time generate message with said who-what-where-when-how of action and identified integrated objects or application links and present to connected or selected or matched users, wherein said links enables viewing user to participate same activity as of another user or source or subject user.
   (2) User Y join group ABC, wherein links enables viewing user to join said group.
Central unit receives and stores each user of network, user profile(s), User selected and installed applications, communication channels & subscribed services for facilitating user's various activities and user connections including friends and friends of friends.
Central unit or system monitors, records or logs or tracks, stores, ranks, indexes, filters & process user's filtered or selected or matched one or more actions, activities, To-Do, events, transactions including who, what, where, when, how, with whom about action and identify related and interacted one or more objects, profile(s), interactions, users, links, pages, media contents & data, applications, networks, groups, services identity in a network or from external domains like User [B], Brand ABC, User [A], Application—Game with accessible link indicating interaction source(s) or source(s) of action, message source (from), matched or selected or connected destination or viewing users, Action doer and auto generates and present said one or more generated messages to matched or selected or connected destination or viewing users.
(5) Service based social network Communication Channel where user provides one or more services to other users of social network including task, work, searching, sharing, marketing, advertising, communication services and user can subscribe one or more services of other users as describe in U.S. patent application Ser. No. 12/847,875, titled: “A System and method of Service Based Social Network”.
(6) Human mediated search engine services Communication Channel in which user send search query or question to one or more expert human agents based on auto matchmaking or user selection or determination and one or more expert human agents provided search result(s) or answer(s) to related searcher or asker. Central unit stores, indexes and process said search query and related responses and provides search engine to other users for searching contents as describe in U.S. patent application Ser. No. 12/847,875, titled: “A System and method of Service Based Social Network and expert human mediated search engine”, U.S. patent application Ser. No. 12/974,998, titled: “Div-12: A method and system for managing resources for providers” and U.S. patent application Ser. No. 12/975,016, titled: “Div-13: A method and system for requesting social services from group of users”.
(7) Unified & Integrated Communication Channel where user can create or initiate plurality of communications and attach & detach connected & selected users and communication applications including email, chat, IM and user can send request for joining one or more communications or invite other users for joining communication as describe in U.S. patent application Ser. No. 12/975,036, titled: “A method and system for integrated online communication and collaboration”.
(8) Publishing Communication Channel wherein user or system can dynamically publish and present user content and data as per subscriber users selection and preferences as describe in U.S. patent application Ser. No. 12/973,387, titled: “A method & system for publishing and subscribing in social network”.
(9) Sharing Communication Channel where user can share content from external domain to any communication channel and connected users of existing domain as describe in U.S. patent application Ser. No. 12/948,483, titled: “A method and system of sharing in a plurality of networks”.
(10) User created Group(s) and Dynamic Group(s) Communication Channel wherein user can create one or more public, private and shared groups for communication, collaboration, workflow, participating, searching & sharing and system dynamically creates one or more groups based on user activities, online availability, location, date & time and combination thereof for communication, collaboration, workflow, participating, searching & sharing as describe in U.S. patent application Ser. No. 11/995,343, titled: “Method and system for communication, publishing, grouping, advertising, searching, sharing and dynamically providing a Journal Feed” and divisional U.S. patent application Ser. No. 13/045,490, titled: “A system and method for managing dynamically created groups”.
(11) Search Macro Communication Channel in which system monitors, records, stores, indexes and process user's one or more keywords specific search process related sequences of actions & events and allow user to edit search process related one or more actions, events and providing said search macros to other users, connected users and subscribers as describe in U.S. patent application Ser. No. 12/847,853, titled: “A System and method for Creating, Searching and Using a Search Macro”
(12) Universal Desktop and Database Resource searching Communication Channel in which system send search query to matched user's desktop based on index data and users desktops act as distributed search server and matched or selected search results send to related searching user(s). Central unit also stores, indexes ranked and selected said searched contents and making them available to other users of network as describe in U.S. patent application Ser. No. 12/847,879, titled: “A System and Method for Universal Desktop & Database Resources Searching, Subscribing and Sharing” and U.S. patent application Ser. No. 12/853,108, title: “A system and method of peer to peer network”
(13) Advertisement Communication Channel in which advertisers and relevant and matched users of network can interact, communicate, transact with each other as describe in U.S. patent application Ser. No. 12/973,351, titled: “A method & system for Intelligent Targeting of Advertisements” and U.S. patent application Ser. No. 12/847,840, titled: “A system and method of targeting advertisements and providing advertisements management”
(14) Brands Social Network Communication Channel in which user selects or inputs brands and identification data based on relevant templates and system creates public, private and shared networks based on said brands and identification data for e-commerce, review, communication, collaboration, workflow, participation, searching & sharing as describe in U.S. patent application Ser. No. 12/954,564, titled: “A METHODS AND SYSTEMS FOR BRANDS SOCIAL NETWORKS (BSN) PLATFORM”.
   Other Communication Channels:
(15) Network(s) Communication Channel where users can join or create one or more networks for communication, collaboration, workflow, participation with other users' activities, searching & sharing within network(s).
(16) Searching Communication Channel in which user can initiate search process and system auto matching online related users including connected users for searching & sharing search result collaboratively,
(17) Video & Photo Sharing Communication Channel wherein user can share refers, view, upload one or more videos and provide ranking or rating and comments. System also monitories, records, filters and stores user's video related activities and actions including viewing particular video, uploading video, commenting and rating a video and auto generating messages and attaching links of video and source user with said video related user's activities and sharing with other connected or filtered users of user, so other user can view said video or read comments & rating on video.
(18) Messaging Communication Channel in which user can post one or more messages including any media data like text, video, link or URL, video, photo to selected and connected users of network.
(19) Application & Service Specific Communication Channels including News, Blog, E-commerce, Search, Share, Tasks, Work, Finance, Travel and like.
(20) New and existing known & available Communication Channel from central unit and 3^{rd} parties' developers, service providers and users.
(21) One or more Combination of Communication Channels

FIG. 6 illustrates an exemplary GUI 6030 for various user actions on one or more selected published and/or subscribed contents, messages, communications, active links, applications, services, objects including attach or detach publishers, subscribers, connected users, receivers, active links, group members and forward, transfer, assign, search, match, share, filter, sort, order, group, categories, bookmark, add, update, delete one or more published and/or subscribed contents, messages, communications, active links, applications, services, objects, view logs, actions, transactions, events, activities & communications details, report spam, abuse & violation, set tracking status, provide comments & ranks, communicate with publisher or subscriber of publications, shared contents & messages, accessing of active links related each action details and provide user defined or auto recorded action details.

FIG. 6 illustrates an exemplary GUI 6000 for (4060) managing and using various types of sort 6040, filter 6050, search 6060, views 6070, installed applications 6080 and user connections 6090.

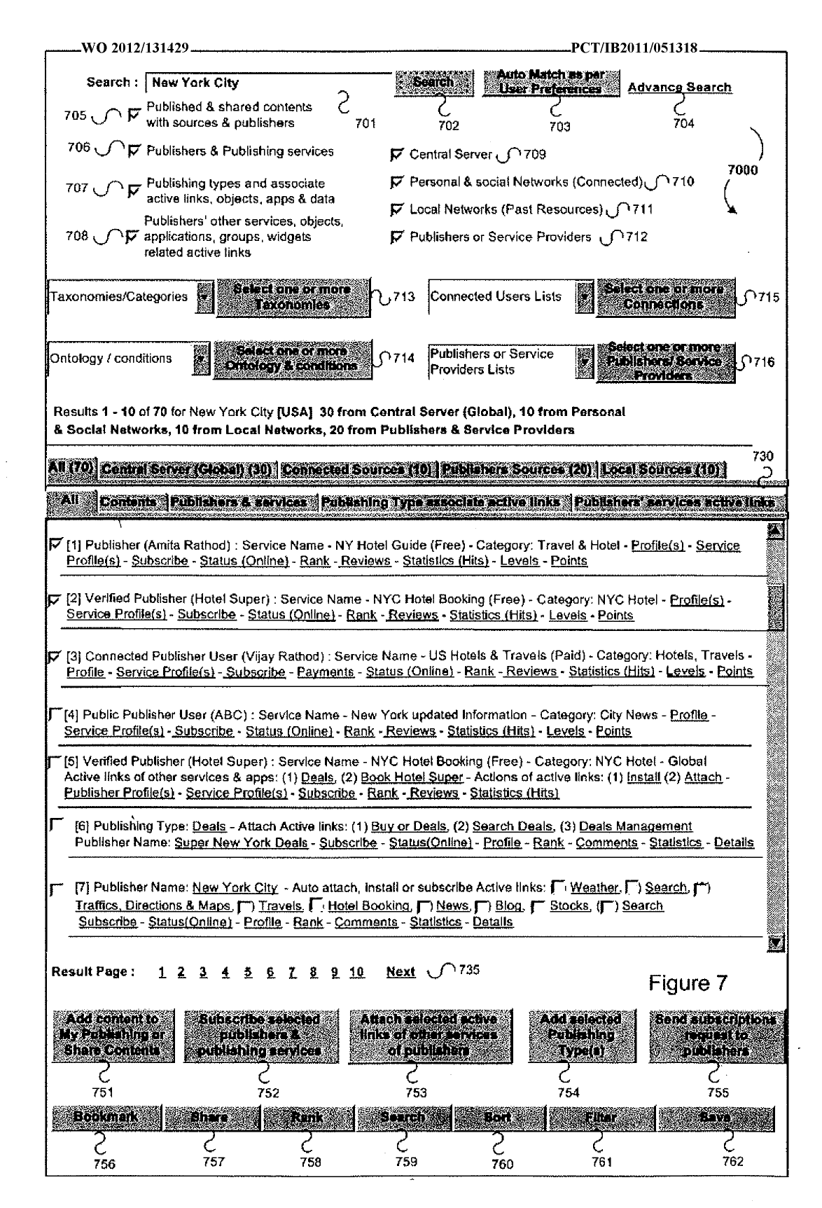

FIG. 7 illustrates an exemplary GUI 7000 for search engine for searching all public published and shared contents with sources and publishers, publishers, publishing services, publishing types and associate active links, objects & data, publishers' other active links related to other services, applications, objects, networks, groups, widgets. Central unit can receives, stores, indexes and processes each published contents, active links and associate objects & data, user profiles, publishers, subscribers, subscriptions, connections, privacy settings and preferences. 701 shows user can enter search query with one or more search criteria and 702 press search button or 703 auto match as per one or more user preferences. User can use 704 advance searches for selecting one or more search criteria including data range, 713 categories, taxonomies, 714 ontologies, conditions, rules, language, location, content types like text, video, audio, photos, images, files or documents, objects, active links, applications, sources like one or more selected publishers, services, connected users, groups and networks. User can select one or more options 705-708 including 705 for searching published & shared contents with sources & publishers. User can subscribe selected one or more publishers or services of publishers based on searched content associate sources. User can search one or more 706 registered publishing services of publishers. User can search, attach, install one or more 707 publishing types and associate active links, objects & data for adding and registering new publishing services. User can search, subscribe, install and attach 708 other services, objects, applications, groups, widgets and related active links of publishers. User can 709 search from central server (global), 710 search from 715 selected personal or social networks of connected users, 711 search from local networks and search from 716 selected one or more publishers & service providers. Based on above mentioned search query, preferences, conditions and selections search engine presents categories search results 730 to searching user. User can select tab for filtering search results. User can select one or more search results add selected contents to published or shared contents 751, user can 752 subscribe selected publishers for receiving publications including messaging, communications, updated status, deals, information, news, micro blogging, notifications, offers, supports and like, 753 user can search, select and install, subscribe & attach one or more active links of one or more publishers related to other services, applications, objects, web site, multimedia contents, groups, networks of publisher(s) and subscribe plurality of other services, 754 user can search publishing type and associate one or more active links and related one or more applications, application features, input system, objects, multimedia contents, privacy settings for adding and registering new publishing services and user can 755 send request to one or more selected publishers for subscribing selected publishing services. User can access each search result and view profiles, ranks, comments, reviews, statistics, levels, points, online status of publishers and publishing services. User can subscribe free or paid services. User can attach, install, subscribe one or more selected active links with user' profile page. User can navigate search results 735. User can further take one or more actions on one or more selected search results including bookmark, search within search result, share, give rank, sort, filter and save search results.

In one embodiment, a method for dynamic publishing and subscribing in a network(s) environment comprising:
registering user with profile and enabled user to act as publisher and/or subscriber;
storing each registered user's subscribers, subscriptions, connections, privacy settings & preferences, subscribed and published one or more publications, contents, active links and associate objects & data;
allowing user to subscribe one or more publishers and/or one or more publication types of one or more publishers of network;
allowing publisher to dynamically publishing publications based on publishing type selections 4003 and publisher specific global & default active links and associate objects & data 5096;
dynamically presenting publishing type specific publishing input system, active links 4002 and application features for drafting & managing publications 4004;
allowing publisher to dynamically publishing each publication with or without active links to subscribers and connected users 4003; and
dynamically presenting said published publication 4005 with publishing type specific application features 4025 to target subscribers 4018 and connected users 4020 or auto installs or attach one or more publisher specific global & default active links and associate objects & data with subscriber's profile page 4050.

In one embodiment, subscriber of publisher can dynamically access publishing type specific publications based on dynamic publishing type specific presentation and application features and enables subscribers to dynamically access publisher specific global & default active links and associate objects & data.

In one embodiment, publisher can dynamically manage, add, edit, remove, upload, upgrade, search, select one or more publishing types, publishing type associate dynamic input system, active links and associate objects, applications, services, widgets, multimedia data, Web pages, profile objects, networks, groups and like, publishing type specific dynamic application features, publishing type specific subscribers, subscriptions, connections, privacy settings, customization settings, preferences, prospective publication contents & templates, metadata, shared profile & publisher data, rules & conditions, advertisement.

In one embodiment, publisher can dynamically manage, add, edit, remove, upload, upgrade, search, select publisher specific one or more global & default active links and associate objects & data including one or more applications, services, widgets, multimedia data, Web pages, profile objects, networks, groups, preferences, privacy settings, metadata, templates, conditions & rules, customization settings.

In one embodiment, subscriber of publisher can access each publication, take one or more actions on publications, view metadata, provide comments and rank, search, sort, categories, filter one or more publications and access publication associate active links, wherein said active links enables user to communicate, collaborate, search, share, give & receive response, create groups, social network, buy and sell, make payment & transactions, participate with publisher(s), 3^{rd} parties service providers and other users of network.

Various Examples for Various Embodiments of Inventions:
1. Publisher User Example: User [Y] registers with network [WW] with profile(s) for publishing publications and contents to any subscribed users and/or subscribing one or more types of publications from one or more publishers. Users of network [WW] are enabled to search and/or subscribe plurality of publishers including Publisher [Y] based on profile, publications, publication types & categories, active links and associate objects & data. Publisher User [Y] creates 20 connections 4020 based on invitations, find friends from network and has 10 subscribers 4018 from network. Publisher User [Y] can use default publications types 4001, 5010, upload & add one or more new publication types & associate objects 5091 & 5092 and search, select and add one or more publication types from central search engine 5093. Publisher User [Y] can manage each publishing type specific each publishing 5095 and manage & publish publisher specific global, public or private & default active links and associate objects & data which are install, display or subscribed 4050 by each subscriber of publisher automatically with or without privacy settings & permission and/or manually based on subscription, searching, matching, preferences, privacy settings, interest, behavior, connections, selections, invitations, suggestion, user's activities, actions, events & transactions. Each said published global, public or private & default active links and associate objects & data are display to publisher's profile or publisher's page 4025 with hit statistics, analytics, where Publisher User [Y] can apply privacy settings, customization settings, view analytics & hit statistics, view logs of user activities, actions, events & transactions, communicate with subscribers, remove, edit, upload, update & upgrade one or more active links and associate objects & data.
For example Publisher User [Y] selects dynamic publishing type 4001 (5) “Video Sharing” and system dynamically presents dynamic publishing type specific input system and associate active links 4002 for drafting, previewing publication & attaching message associate active links and system also dynamically presents dynamic publishing type specific application features & services 4004 for managing, processing publication contents, applying publishing privacy settings & preferences, associating metadata including categories, details, payment information, keywords, help and like, managing & creating publishing type specific subscribers, connections. For example when Publisher User [Y] selects dynamic publishing type 4001 (5) “Video Sharing” system displays video related application features and functionalities including video editor for editing video, record video for capturing video, video lists for selecting video for publication(s), video management, upload video and attaching one or more videos with publication or message. Publisher User [Y] draft message 4002 “My NYC travel videos with explanation” with attachments Videos select from Video list application feature 4004 and attach active links (1) View Video and (2) Video Album, selected from Active Links combo box 4002. Publisher User [Y] apply privacy settings, preferences and other settings with said message or video sharing type publication or sharing contents and post or send said message and associate data to subscribed users.
Central unit receives, stores, indexes, process all publication contents of all publishers including Publisher User [Y] for making them searchable for other users and dynamically present 4005 said publication to all subscribers of publications and/or connected users. Receiving and viewing or subscribed User can access one or more said received publications, associate active links and utilize publication type specific features 4025 for managing publications. User can provide comments, ranks, action details on said one or more publications from one or more subscribed publishers. System monitors, records, logs, stores one or more user actions, events, transactions on said publications and send or present to related publisher(s) based on permission and privacy settings. Concurrently user can also use and access publisher specific one or more global & default active links and associate objects & data 4050 for subscribing, receiving one or more other services of publisher including use applications, play games, subscribe news service, view information, browse data, search, share, communicate, collaborate, participate with publisher and other users, make payment and purchase products & services. So users not only receive publications from subscribed publishers but also access, subscribe, and use other services of publishers.

2. Subscriber User Example:
Central Unit registers the User [Y] with profile and enabled User [Y] to act as publisher and/or subscriber and stores each registered user's including User [Y]'s subscribers 4018, subscriptions 4019, connections 4020, privacy settings & preferences, subscribed and published one or more publications, contents, active links and associate objects & data and allow users including User [Y] to subscribe subscriptions of one or more publishers and/or one or more publication types of one or more publishers 4019 of network. Subscribing User [Y] receives each publications and/or publication type specific publications from one or more subscribed publishers 4005. System dynamically presents said each publication in tabular format which enables Subscribing User [Y] to dynamically access & manages each publishing type specific publication contents with associate application features 4025. User can sort, filter, search and select views for one or more publications and one or more publication types specific one or more publications 4006. User can take one or more actions on published and/or subscribed one or more publication contents 4029. User can expand and collapse tree and add, detach & remove one or more publications 4009. User can view user's own publications 4009 (1) or 4010 with subscribed publishers publications 4009 (1) to (8). User can select one or more publications and take one or more group actions on said selected one or more publications 4009 (1) to (8).
Subscriber User [Y] publish publication 4009 (1) to subscribers 4018 and connected users 4020 which also present to User [Y] 4009 (1). Subscriber User [Y] can receives and views 4009 (2) to (8) all publications from all publishers 4025. For example Subscriber User [Y] subscribe to publisher “Super Mobile” and receives each publications from publisher “Super Mobile” including publishing type “Deals & E-commerce” related message 4009 (2) or 4011 with date & time, publishing type, ranks & hit statistics, categories, metadata, source, associate one or more accessible active links. User can access said active links for purchase mobile from super store and/or view presentation. User can take one or more actions on said message or publications and system monitors, records, stores, logs said one or more user's actions and present to user. User can use publishing type specific general application features 4025 and User can use, access and manage publisher specific global & default one or more active links and associate objects & data 4050, which enables user to access other services of publisher “Super Mobile” including view information, presentation, communicate with experts, subscriber newsletter and other publications & services and like. Another example 4009 (3) or 4012 where user receives various types of publications from categories publishers, Example 4009 (4) or 4013 shows user can receives one or more preferences based auto publications from central unit. Example 4009 (5) or 4014 show user can receives deals related messages from publisher “GroupOn™” with metadata and accessible active links which enables user to make offer and buy from publisher in unified, integrated manner. User receives publication contents from plurality of other publishers including publisher “Exchange Rate Service” 4009 (6) or 4015 for receiving daily dollar rate in rupees and attach active links enables user to buy and sell currencies, receiving message from publisher “Indian Air Lines” 4009 (7) or 4016 and news publisher “ABC News” 4009 (8) or 4017. User can access each said publisher's default & global active links and associate objects & data 4050 for receiving, subscribing, accessing more services of said each publishers including access full features e-commerce & deals applications, news services, list of news, book tickets, posting job or resume and receiving preference based jobs from publisher.

1-48. (canceled)

49. A method in a network environment comprising:
enabling a user of said network to act as a publisher for dynamically publishing and presenting one or more dynamic publications from one or more dynamic sources via a dynamic interface of publisher to corresponding dynamic interface of set of receiving users at one or more dynamic destinations, wherein said dynamic interface comprising one or more publishers, receivers, publication types, publications and content items specific dynamically installable, updatable, customized, configurable, attachable, pluggable, connectable and accessible dynamic interface(s) including inputting interface(s), selection interface(s) and presentation interface(s), active links refereeing to applications, services, objects, web parts, controls, multimedia data, application features, actions, lists and associate metadata, updatable profile, data, advertisements, subscribers, subscriptions, connections, privacy settings & preferences, for publishing, presenting, managing and accessing dynamic publication and associate content items in an integrated and unified manner;
dynamically presenting said dynamic publications to dynamic interface of set of receiving users at one or more dynamic destinations; and
enabling said set of receiving users to dynamically access said each dynamic publication and associate content items and each publisher, publication & content item associated or attached dynamic and accessible interface(s) including presentation interface(s), selection interface(s), application features, active links via dynamic interface, wherein said dynamic and accessible active links enables viewing user to take plurality of actions including dynamically access, communicate, collaborate, response, workflow, search, share, create social networks, transact and participate.

50. The method according to claim 49, wherein publication or presented contents comprising of categories message stream(s), shared contents, content items, message streams, activities streams, communications, responses, search results, advertisements, structured and unstructured data, web site content and/or application features, multimedia data, applications, objects, web site, at least part of web site and plurality of customized publication types specific contents.

51. The method according to claim 49, wherein set of receiving users comprising one or more dynamic subscribers or members, connected users, determined receivers of the publication, searching users, requestors, viewing users and auto matched target recipients.

52. The method according to claim 49, wherein each publication of publisher comprises of associated registered profile said profile comprising of publisher details, publishing type, categories, name, descriptions, associate metadata, active links and related objects, applications, services, privacy settings, conditions & data, authentication information, payment information, preferences and assigned unique identity and Uniform Resource Locator (URL) of the publisher and each publication of publisher.

53. The method according to claim 49, the method comprising enabling publisher to register, identify, define, create, manage and publish one or more publications or publication types.

54. The method according to claim 49, comprising enabling to select and/or automatically attach or associate one or more active links with publisher, publication, each content item of the publication, by predefined entities comprising of publisher, a central server unit, user, subscriber, providers & developers of active link and active link refereed or associated objects, applications, services, multimedia and/or 3^{rd} parties external domains, web sites, applications, services, databases, networks and devices.

55. The method according to claim 49, wherein dynamic web site comprises of contents and/or active links.

56. The method according to claim 49, wherein dynamic web site can selectively manage, store, host, process, develop, create, register, update, upgrade, publish and present each part of web site, said part of website including contents and active links.

57. The method according to claim 49, wherein one or more publishers share one or more active links.

58. The method according to claim 49, wherein subscribers subscribe contents and active links of one or more publications of one more publishers and in any combination thereof.

59. The method according to claim 49, wherein publication of publisher comprises of profile, data and metadata, wherein said profile, data and metadata includes name, categories, types, keywords, date & time, privacy settings, preferences, subscription information, payment information, access information, publisher name & profile, URL of publisher and publication, description, associated active links, hit statistics, subscribers including unique user identities, names, profile links, account information, privacy settings, preferences, hits, provided comments and ranks, information about user's interactions, actions, activities, transactions, behavior, status, events with publication including contents or content items and/or active links.

60. The method according to claim 49, wherein dynamic publisher is enabled to dynamically upload, host, search, match, select, purchase and attach, detach, install, updates, upgrades and manage dynamic publication(s) specific connectable input & presentation system(s), application, dynamic web site(s), plug-ins, associate dynamic & accessible application features, profile, privacy settings, preferences and active links with dynamic interface or profile or web page of publisher.

61. The method according to claim 49, wherein dynamic interface of publisher is adaptable to dynamically and automatically connect, plug, integrate, merge, attach, generate, store, present and manage dynamic publication(s) specific connectable input & presentation system(s), applications, dynamic web site(s), plug-ins, associated dynamic & accessible application features, profile, privacy settings, preferences and active links.

62. The method according to claim 49, the method comprising enabling dynamic publisher to publish, present, update, and manage one or more publications based on said categorized dynamic publication(s) specific dynamic, connectable input & presentation system(s), applications, dynamic web site(s), plug-ins, associated dynamic & accessible application features, profile, privacy settings, preferences and active links.

63. The method according to claim 49, the method comprising enabling publisher to publish, present, update, and manage one or more categorized publications based on selection of publication specific provided connectable input & presentation system (s), applications, dynamic web site(s), plug-ins, associated accessible application features, profile, privacy settings, preferences and active links.

64. The method according to claim 49, wherein the method comprising presenting categorized publication specific dynamic input & presentation system(s), applications, dynamic web site(s), plug-ins, associated dynamic & accessible application features, profile, privacy settings, preferences, subscribers and active links to publisher based on selection of categorized publication or dynamic web site name from list.

65. The method according to claim 49, wherein further enable users of network to subscribe (following), register, and connect with one or more publishers and/or publications with or without profile.

66. The method according to claim 49, the method comprising allowing each publisher to send each message or updated dynamic contents of each publication to each subscriber or member of each publication of each publisher and/or receive each message of each subscribed publication of each publisher.

67. The method according to claim 49, wherein dynamic interface of subscriber is adaptable to dynamically and automatically present, install, connect, plug, integrate, merge, subscribe, attach, generate, update, upgrade and synchronize subscribed dynamic publication or message stream specific connectable input & presentation system(s), application(s), dynamic web site(s), plug-ins, associated dynamic & accessible application features, profile, privacy settings, preferences and active links.

68. The method according to claim 49, the method comprising allowing user to search, match, select, install, subscribe organize, sort, filter, categories, attach, detach, take one or more actions, provide rank & comments, apply privacy settings & customization settings, update, upgrade publisher or publications specific active links.

69. The method according to claim 49, the method comprising enabling dynamic subscribers to dynamically access dynamic contents or message streams received from dynamic publishers based on publisher or publication or message stream of publisher specific presentation system or application or dynamic web site or plug-ins and active links, from dynamic interface or profile or web page of subscriber.

70. The method according to claim 49, the method comprising presenting and installing publisher and publication specific dynamic presentation system, applications, dynamic web sites plug-ins and active links to subscriber is based on selection of message or content item from list of publishers or publications including categorized message streams, content items, messages, and content of dynamic web sites or at least part of web site.

71. The method according to claim 52, the method comprising enabling user or subscriber to dynamically access publisher or message stream or publication or dynamic web site specific active links.

72. The method according to claim 49, the method comprising enabling dynamic subscribers for entering, inputting, selecting URL or unique name of dynamic publisher, publication, associated categories message stream, publication, source of publisher for subscribing, installing, accessing, receiving, updating and synchronizing publisher or publication or message stream of publisher specific presentation system or application or dynamic web site or plug-ins and active links from dynamic interface or profile or web page of subscriber.

73. The method according to claim 49, wherein subscription of publications is based on membership, inputting, selecting, clicking publisher or publication URL and unique identity including unique name, namespace, GUID and subscribe, sending request or inviting others for approval, connections, selections, contacts, search people, find friends from contacts, source associated with profile, search sources from source associated with each searched message(s), accessing user created categories lists of sources, up-to (N) depths, search subscribers and subscriptions of each public user, one or two way match making preferences for auto generated dynamic messages associated with accessible objects, nodes and contextual application features, rules, conditions, privacy settings, categories, taxonomy wise directories and lists, auto match making based on preferences, profile, user data, user activities, actions, interest, behavior, events and transactions and any combination thereof.

74. The method according to claim 49, wherein set of users comprising determined users, wherein the step of limiting or determining of one or more target recipients comprises searching, matching and selecting one or more users from one or more categorized contacts or connections or dynamic relationships and/or auto selecting based on one way matchmaking preferences of sender or receiver or two way match making preferences of both sender and receiver and applied privacy settings for auto generated dynamic messages and/or selecting or auto matching all or one or more subscribers or categories of subscribers of message stream(s) of the sender and any combination thereof.

75. The method according to claim 49, wherein the step of determining one or more target recipients comprises: selecting, auto matching or searching a database for one or more target recipients based on one or more preferences, filters, rules, profiles, relevancy, behavior, interests, subscribers, connections and dynamic relationships; and/or matching the sender's one or more selections, subscribers and preferences.

76. The method according to claim 49, wherein the allowing users to create public or private or shared categories lists of one or more senders or publishers or sources; storing and maintaining taxonomy classification of the categories of lists with metadata associated with each list, said metadata comprising a list name, categories name, details, subscribers and subscriptions, privacy settings, creator name or ID, date of creation and/or allowing users to search, match or subscribe to said categories lists of other users.

77. The method according to claim 49, wherein dynamic publications comprises multimedia data including text, html, audio, videos, images, photos, map, files or documents, & URLS, applications, objects, web pages, accessible active links, data records, databases, lists, identities, user connections, messages, templates, survey forms, keywords, interactive objects, widgets, interfaces, controls including text box, label, combo box, menus, buttons, list, user actions, selection controls & windows, advertisements, questions, answers, blogs, deals, yellow pages, directories, downloads, binary instructions, rules, commands, categories, groups, networks, profiles, privacy settings, preferences, mapping information, user data, user generated contents including comments, ranks, reviews, search queries, search results, communications, bookmarks, workspace, attachments, activities streams and plurality types of digital contents.

78. The method according to claim 49, wherein presenting one or more active links based on source, publisher, publication name, categories message stream name, type of content, categories of contents or sources or publishers, keywords associate with content or source & publisher's profile.

79. The method according to claim 49, the method comprising:
enabling publisher, to dynamically publish or update or present active links with publication or categories message stream or source of content or at least part of web site from one or more networks;
dynamically presenting publisher specific active links;
enabling user to access, install, invoke, interact and connect with one or more active links; and
maintaining and storing information related to access, interactions, actions, activities, transactions, connections, relationships, operations, events, status, and behavior of user with one or more active links.

80. The method according to claim 49, the method comprising enabling publisher for identifying, defining, creating, generating, developing, uploading, customizing, attaching, updating, registering, publishing, maintaining and providing one or more identified, dynamic, contextual, pluggable, loosely coupled, portable, interactive, standardized, crawl able, active links.

81. The method according to claim 49, wherein publisher can dynamically manage, add, edit, remove, upload, upgrade, search, select publisher specific one or more active links.

82. The method according to claim 49, the method comprising presenting publisher specific active links to predefined and prominent place of dynamic interface or profile of subscriber of message stream.

83. The method according to claim 49, the method comprising presenting publisher specific active links to prominent place of dynamic interface or profile of publisher of message stream.

84. The method according to claim 49, the method comprising dynamically highlighting or presenting message or message stream or content publisher specific active links to subscriber or user based on specific message or content selection or clicking on particular message from list of message streams or list of content items.

85. The method according to claim 49, wherein presenting publisher specific active links based on user subscription or membership of one or more publications of publisher.

86. The method according to claim 49, wherein active links comprise one or more applications, services, objects, shared objects, web parts, widgets, micro web sites, multi AI agents, multimedia data & contents, people, networks, groups, links or URLs, ID, User Profiles, profile objects, attachments, informational links including advertisements, deals, lists, messages, web URL, multimedia data and shared workspaces for collaboration, utilities, web pages, profile data, connections, database, filtered data, search results, user activity or action streams, people, nodes of social graphs or networks, application features, presentation systems, interface, user actions objects, one or more menus, lists, combo box, interface, windows, toolbar, tab & controls for user selections of one or more options or resources, actions, tasks, executing binary instructions from one or more networks, external domains, applications, services and devices.

87. The method according to claim 86, wherein said active links associate metadata comprise reference node link name, namespace, one or more types, profiles, categories, taxonomies, details, descriptions, keywords, sources, associate each object data including accessible URL(s), reference link(s), name, categories, identity, sources, properties, size, details, descriptions, invocation logic, authentication information, associate user name, user identity & user password, information & link of one or more profile objects of connected users of user, security policies, privacy settings, presentation settings, author, help, date & time, types including multimedia data types like file, text, video, image, audio & link, application, service, object, web page, widget, group object, profile object, database.

88. The method according to claim 49, the method comprising enabling user or subscriber to take one or more actions on publications or message stream or shared contents or content items or web site or at least part of web site and/or active links, the actions comprising search, match, select, sort, filter, subscribe, download, install, access, update, upgrade, ask for support, bookmark, re-share, refer, categories, attach, detach, provide rank & comments, save, synchronize, un-subscribe, uninstall, block, remove, report spam or mark as spam, select views of presentation include tree, tabular, list style of presentation, set privacy settings, presentation settings, tracking status, provide preferences, share user profile and user data with one or more publishers and/or connected users of user and/or advertisers or developers or providers and/or central server.

89. The method according to claim 49, the method comprising enabling source or publisher to take one or more actions on publications or message stream or shared contents or content items or web site or at least part of web site and/or active links, the actions comprising managing, storing, processing, editing, searching, match, select, filter, sort, order, rank, bookmark, draft, update, download, upload, update, upgrade, provide support, attach, detach, publish, post, synchronize, categories, apply privacy settings and presentation settings, associate metadata, remove, re-share, re-publish, collaborate with other publishers and/or publications, attach or associate one or more active links with publication, update publication profile, make publication searchable, associate advertisements, invite subscribers, accept request of users for subscribe publication(s), view hit statistics, view payments information of subscribers, access subscribers or profile of subscribers of publications, manage information about user's interactions, actions, activities, transactions, behavior, status, events with publication including contents or content items and/or active links.

90. The method according to claim 49, the method comprising enabling publisher to dynamically send each subscriber specific publications or message stream or shared contents or content items or web site or at least part of web site and/or accessible active links based on user preferences, privacy settings, profile, user data including information about user's actions, activities, interactions, transactions, status, location, behavior and connections.

91. The method according to claim 49, the method comprising providing search and match for searching, matching, filter, selecting and/or subscribing publishers, publications, categorized message streams, contents, content items, dynamic web site, at least part of published dynamic web site, lists, groups, connected or related users of user, active links from central server unit, publishers, providers, developers, user profile, connected users profiles based on one or more keywords, categories, criteria, rules, conditions, selections, type of contents, type of active links.

92. The method according to claim 90, wherein a search result comprises of a list of searched publishers with accessible metadata & parameters including publisher's profile link, publication or publishing type profile link, publisher name, publication service name, description, rank, grade, namespace, hits statistics, payment terms, metadata, date & time, language, location, domain, associated taxonomy or categories, keywords, subscribers' reviews & comments, service type including public, private, verified, paid, availability status including online, offline, away, timings and service usage details.

93. The method according to claim 49, the method comprising enabling users to dynamically and automatically install, subscribe to or present lists for user's manual selections of one or more active links, and attach or associate active links with user profile based on user preferences, selections, search, match, subscriptions, subscribers, connections, ranks, privacy settings, user & connected users one or more subscriptions of publishers, user activities, actions, events, transactions, location, interest, behavior, user profile, user data, suggested lists, message or publication content specific active links and share selective user profile and user data with said one or more applications, services, web sites, networks, widgets, groups, networks based on privacy settings and preferences.

94. The method according to claim 49, the method comprising allowing a user to create and update one or more categories lists of identified active links which are controlled by user and exist in publishing network, said creation and updation of categorized lists is based on user selection, uploaded by user, search & match, suggested & provided by connected & matched users, suggested list or auto generated by central unit based on user profiles, user data, user activities, recorded user's actions, past responses, interest, list of active links, list of active links of connected users, installed applications and provided by 3^{rd} parties developers, service providers and advertisers based on users privacy settings and preferences.

95. The method according to claim 49, the method comprising allowing one or more senders and receivers of active link to share active link & active link associated objects and wherein said object relates to at least part of user data with one or more users based on privacy settings for communication, grouping, workflow and collaboration.

96. The method according to claim 49, the method comprising invoking or opening or presenting dynamic, identified & accessible active link(s) associated resource(s) in an inline, unified, in process, integrated manner, in same domain, within window or web page or browser or application or any types of presentation interface, container & widget, open in separate window, web pages, application, widget, presentation interface, container and in separate or external domain(s) or access in silent mode or accepting only user actions & clicks.

97. The method according to claim 49, the method comprising dynamic interface or container is enabled to dynamically attach, detach, enabled, disabled, host, integrate, plug, merge, combine, search, match, select, filter, connect, download, upload, subscribe, un-subscribe, install, un-install, configure, access associate profile, user data, logs, metadata, subscribers, subscriptions, connections, ranks, comments, statistics, status, user actions, set privacy settings, set presentation types including tree, list, visual, & tabular, share user data, switch, drag and drops, scroll, minimize, maximize, open, close, access, add, remove, update, upgrade, monitor, log, sort, order, rank, share, refer, bookmark, categories, synchronize, take one or more dynamic actions, invoke via URL or namespace and presents in plurality of ways, a plurality types of dynamic interfaces from plurality of sources including inputting interfaces, selection interfaces, system default interfaces, and presentation interfaces, dynamic & accessible active links including application features, applications, services, controls, multimedia data, metadata, objects, and connectable nodes of network(s) in an integrated and unified manner.

98. A system in a network environment comprises:
a dynamic interface of publisher is configured to enable a publisher to dynamically publish and present one or more dynamic publications from one or more dynamic sources via a dynamic interface of publisher to corresponding dynamic interface of set of receiving users at one or more dynamic destinations, wherein said dynamic interface comprising one or more publishers, receivers, publication types, publications and content items specific dynamically installable, updatable, customized, configurable, attachable, pluggable, connectable and accessible dynamic interface(s) including inputting interface(s), selection interface(s) and presentation interface(s), active links refereeing to applications, services, objects, web parts, controls, multimedia data, application features, actions, lists and associate metadata, updatable profile, data, advertisements, subscribers, subscriptions, connections, privacy settings & preferences, for publishing, presenting, managing and accessing dynamic publication and associate content items in an integrated and unified manner;
a dynamic interface of publisher is configured to dynamically present said dynamic publications to dynamic interface of set of receiving users at one or more dynamic destinations; and
a dynamic interface of publisher is configured to enable to said set of receiving users to dynamically access said each dynamic publication and associate content items and each publisher, publication & content item associated or attached dynamic and accessible interface(s) including presentation interface(s), selection interface(s), application features, active links via dynamic interface, wherein said dynamic and accessible active links enables viewing user to take plurality of actions including dynamically access, communicate, collaborate, response, workflow, search, share, create social networks, transact and participate.

99. The system according to claim 98, wherein publication or presented contents comprising of categories message stream(s), shared contents, content items, message streams, activities streams, communications, responses, search results, advertisements, structured and unstructured data, web site content and/or application features, multimedia data, applications, objects, web site, at least part of web site and plurality of customized publication types specific contents.

100. The system according to claim 98, wherein set of receiving users comprising one or more dynamic subscribers or members, connected users, determined receivers of the publication, searching users, requestors, viewing users and auto matched target recipients.

101. The system according to claim 98, wherein publisher or subscriber or user comprises of associated registered profile said profile comprising of details, authentication information, payment information, privacy settings, preferences and assigned unique identity and Uniform Resource Locator (URL) of the user or subscriber.

102. The system according to claim 98, wherein each publication of publisher comprises of associated registered profile said profile comprising of publisher details, publishing type, categories, name, descriptions, associate metadata, active links and related objects, applications, services, privacy settings, conditions & data, authentication information, payment information, preferences and assigned unique identity and Uniform Resource Locator (URL) of the publisher and each publication of publisher.

103. The system according to claim 98, the system comprising publisher is enabled to register, identify, define, create, manage and publish one or more publications or publication types.

104. The system according to claim 98, comprising enable to select and/or automatically attach or associate one or more active links with publisher, publication, each content item of the publication, by predefined entities comprising of publisher, a central server unit, user, subscriber, providers & developers of active link and active link refereed or associated objects, applications, services, multimedia and/or 3^{rd} parties external domains, web sites, applications, services, databases, networks and devices.

105. The system according to claim 98, wherein dynamic web site comprises of contents and/or active links.

106. The system according to claim 98, wherein dynamic web site is configured to selectively manage, store, host, process, develop, create, register, update, upgrade, publish and present each part of web site, said part of website including contents and active links.

107. The system according to claim 98, wherein publishers are adapted to share one or more active links.

108. The system according to claim 98, wherein subscribers are enabled to subscribe contents and active links of one or more publications of one more publishers and in any combination thereof.

109. The system according to claim 98, wherein user is enabled to dynamically publish contents to one or more connected users and determined publishers, and said publishers enabled to selectively republish contents with associated active links to subscribers, wherein subscriber or receivers can access publication specific active links and can edit, update, collaborate, communicate, re-share, view, play and listen received multimedia content items.

110. The system according to claim 98, wherein publication of publisher comprises of profile, data and metadata, wherein said profile, data and metadata includes name, categories, types, keywords, date & time, privacy settings, preferences, subscription information, payment information, access information, publisher name & profile, URL of publisher and publication, description, associated active links, hit statistics, subscribers including unique user identities, names, profile links, account information, privacy settings, preferences, hits, provided comments and ranks, information about user's interactions, actions, activities, transactions, behavior, status, events with publication including contents or content items and/or active links.

111. The system according to claim 98, wherein dynamic publisher is enabled to dynamically upload, host, search, match, select, purchase and attach, detach, install, updates, upgrades and manage dynamic publication(s) specific connectable input & presentation system(s), application, dynamic web site(s), plug-ins, associate dynamic & accessible application features, profile, privacy settings, preferences and active links with dynamic interface or profile or web page of publisher.

112. The system according to claim 98, wherein dynamic interface of publisher is adaptable to dynamically and automatically connect, plug, integrate, merge, attach, generate, store, present and manage dynamic publication(s) specific connectable input & presentation system(s), applications, dynamic web site(s), plug-ins, associated dynamic & accessible application features, profile, privacy settings, preferences and active links.

113. The system according to claim 98, the system comprising dynamic publisher is enabled to publish, present, update, and manage one or more publications based on said categorized dynamic publication(s) specific dynamic, connectable input & presentation system(s), applications, dynamic web site(s), plug-ins, associated dynamic & accessible application features, profile, privacy settings, preferences and active links.

114. The system according to claim 98, the system comprising publisher is enabled to publish, present, update, and manage one or more categorized publications based on selection of publication specific provided connectable input & presentation system (s), applications, dynamic web site(s), plug-ins, associated accessible application features, profile, privacy settings, preferences and active links.

115. The system according to claim 98, wherein the system comprising present categorized publication specific dynamic input & presentation system(s), applications, dynamic web site(s), plug-ins, associated dynamic & accessible application features, profile, privacy settings, preferences, subscribers and active links to publisher based on selection of categorized publication or dynamic web site name from list.

116. The system according to claim 98, wherein further users of network is enabled to subscribe (following), register, and connect with one or more publishers and/or publications with or without profile.

117. The system according to claim 98, the system comprising each publisher are adapted to send each message or updated dynamic contents of each publication to each subscriber or member of each publication of each publisher and/or receive each message of each subscribed publication of each publisher.

118. The system according to claim 98, wherein dynamic interface of subscriber is adaptable to dynamically and automatically present, install, connect, plug, integrate, merge, subscribe, attach, generate, update, upgrade and synchronize subscribed dynamic publication or message stream specific connectable input & presentation system(s), application(s), dynamic web site(s), plug-ins, associated dynamic & accessible application features, profile, privacy settings, preferences and active links.

119. The system according to claim 98, the system comprising user is configured to search, match, select, install, subscribe organize, sort, filter, categories, attach, detach, take one or more actions, provide rank & comments, apply privacy settings & customization settings, update, upgrade publisher or publications specific active links.

120. The system according to claim 98, the system comprising dynamic subscribers is enabled to dynamically access dynamic contents or message streams received from dynamic publishers based on publisher or publication or message stream of publisher specific presentation system or application or dynamic web site or plug-ins and active links, from dynamic interface or profile or web page of subscriber.

121. The system according to claim 98, the system comprising present and install publisher and publication specific dynamic presentation system, applications, dynamic web sites plug-ins and active links to subscriber is based on selection of message or content item from list of publishers or publications including categorized message streams, content items, messages, and content of dynamic web sites or at least part of web site.

122. The system according to claim 98, the system comprising user or subscriber is enabled to dynamically access publisher or message stream or publication or dynamic web site specific active links.

123. The system according to claim 98, the system comprising dynamic subscribers is enabled to enter, input, select URL or unique name of dynamic publisher, publication, associated categories message stream, publication, source of publisher for subscribing, installing, accessing, receiving, updating and synchronizing publisher or publication or message stream of publisher specific presentation system or application or dynamic web site or plug-ins and active links from dynamic interface or profile or web page of subscriber.

124. The system according to claim 98, wherein subscription of publications is based on membership, inputting, selecting, clicking publisher or publication URL and unique identity including unique name, namespace, GUID and subscribe, sending request or inviting others for approval, connections, selections, contacts, search people, find friends from contacts, source associated with profile, search sources from source associated with each searched message(s), accessing user created categories lists of sources, up-to (N) depths, search subscribers and subscriptions of each public user, one or two way match making preferences for auto generated dynamic messages associated with accessible objects, nodes and contextual application features, rules, conditions, privacy settings, categories, taxonomy wise directories and lists, auto match making based on preferences, profile, user data, user activities, actions, interest, behavior, events and transactions and any combination thereof.

125. The system according to claim 98, wherein set of users comprising determined users, wherein the step of limiting or determining of one or more target recipients comprises searching, matching and selecting one or more users from one or more categorized contacts or connections or dynamic relationships and/or auto selecting based on one way matchmaking preferences of sender or receiver or two way match making preferences of both sender and receiver and applied privacy settings for auto generated dynamic messages and/or selecting or auto matching all or one or more subscribers or categories of subscribers of message stream(s) of the sender and any combination thereof.

126. The system according to claim 98, wherein the step of determining one or more target recipients comprises: selecting, auto matching or searching a database for one or more target recipients based on one or more preferences, filters, rules, profiles, relevancy, behavior, interests, subscribers, connections and dynamic relationships; and/or matching the sender's one or more selections, subscribers and preferences.

127. The system according to claim 98, wherein the users are configured to create public or private or shared categories lists of one or more senders or publishers or sources; storing and maintaining taxonomy classification of the categories of lists with metadata associated with each list, said metadata comprising a list name, categories name, details, subscribers and subscriptions, privacy settings, creator name or ID, date of creation and/or allowing users to search, match or subscribe to said categories lists of other users.

128. The system according to claim 98, wherein dynamic publications comprises multimedia data including text, html, audio, videos, images, photos, map, files or documents, & URLS, applications, objects, web pages, accessible active links, data records, databases, lists, identities, user connections, messages, templates, survey forms, keywords, interactive objects, widgets, interfaces, controls including text box, label, combo box, menus, buttons, list, user actions, selection controls & windows, advertisements, questions, answers, blogs, deals, yellow pages, directories, downloads, binary instructions, rules, commands, categories, groups, networks, profiles, privacy settings, preferences, mapping information, user data, user generated contents including comments, ranks, reviews, search queries, search results, communications, bookmarks, workspace, attachments, activities streams and plurality types of digital contents.

129. The system according to claim 98, wherein present one or more active links based on source, publisher, publication name, categories message stream name, type of content, categories of contents or sources or publishers, keywords associate with content or source & publisher's profile.

130. The system according to claim 98, the system comprises:
publisher is enabled to dynamically publish or update or present active links with publication or categories message stream or source of content or at least part of web site from one or more networks;
a dynamic interface is configured to dynamically present publisher specific active links;
user is enabled to access, install, invoke, interact and connect with one or more active links; and
a storage medium for maintaining and storing information related to access, interactions, actions, activities, transactions, connections, relationships, operations, events, status, and behavior of user with one or more active links.

131. The system according to claim 98, the system comprising publisher id enabled to identify, define, create, generate, develop, upload, customize, attach, update, register, publish, maintain and provide one or more identified, dynamic, contextual, pluggable, loosely coupled, portable, interactive, standardized, crawl able, active links.

132. The system according to claim 98, wherein publisher is configured to dynamically manage, add, edit, remove, upload, upgrade, search, select publisher specific one or more active links.

133. The system according to claim 98, the system comprising present publisher specific active links to predefined and prominent place of dynamic interface or profile of subscriber of message stream.

134. The system according to claim 98, the system comprising present publisher specific active links to prominent place of dynamic interface or profile of publisher of message stream.

135. The system according to claim 98, the system comprising dynamically highlight or present message or message stream or content publisher specific active links to subscriber or user based on specific message or content selection or clicking on particular message from list of message streams or list of content items.

136. The system according to claim 98, wherein present publisher specific active links based on user subscription or membership of one or more publications of publisher.

137. The system according to claim 98, wherein active links comprise one or more applications, services, objects, shared objects, web parts, widgets, micro web sites, multi AI agents, multimedia data & contents, people, networks, groups, links or URLs, ID, User Profiles, profile objects, attachments, informational links including advertisements, deals, lists, messages, web URL, multimedia data and shared workspaces for collaboration, utilities, web pages, profile data, connections, database, filtered data, search results, user activity or action streams, people, nodes of social graphs or networks, application features, presentation systems, interface, user actions objects, one or more menus, lists, combo box, interface, windows, toolbar, tab & controls for user selections of one or more options or resources, actions, tasks, executing binary instructions from one or more networks, external domains, applications, services and devices.

138. The system according to claim 137, wherein said active links associate metadata comprise reference node link name, namespace, one or more types, profiles, categories, taxonomies, details, descriptions, keywords, sources, associate each object data including accessible URL(s), reference link(s), name, categories, identity, sources, properties, size, details, descriptions, invocation logic, authentication information, associate user name, user identity & user password, information & link of one or more profile objects of connected users of user, security policies, privacy settings, presentation settings, author, help, date & time, types including multimedia data types like file, text, video, image, audio & link, application, service, object, web page, widget, group object, profile object, database.

139. The system according to claim 98, the system comprising user or subscriber is configured to take one or more actions on publications or message stream or shared contents or content items or web site or at least part of web site and/or active links, the actions comprising search, match, select, sort, filter, subscribe, download, install, access, update, upgrade, ask for support, bookmark, re-share, refer, categories, attach, detach, provide rank & comments, save, synchronize, un-subscribe, uninstall, block, remove, report spam or mark as spam, select views of presentation include tree, tabular, list style of presentation, set privacy settings, presentation settings, tracking status, provide preferences, share user profile and user data with one or more publishers and/or connected users of user and/or advertisers or developers or providers and/or central server.

140. The system according to claim 98, the system comprising publisher is enabled to take one or more actions on publications or message stream or shared contents or content items or web site or at least part of web site and/or active links, the actions comprising managing, storing, processing, editing, searching, match, select, filter, sort, order, rank, bookmark, draft, update, download, upload, update, upgrade, provide support, attach, detach, publish, post, synchronize, categories, apply privacy settings and presentation settings, associate metadata, remove, re-share, re-publish, collaborate with other publishers and/or publications, attach or associate one or more active links with publication, update publication profile, make publication searchable, associate advertisements, invite subscribers, accept request of users for subscribe publication(s), view hit statistics, view payments information of subscribers, access subscribers or profile of subscribers of publications, manage information about user's interactions, actions, activities, transactions, behavior, status, events with publication including contents or content items and/or active links.

141. The system according to claim 98, the system comprising publisher is adapted to dynamically send each subscriber specific publications or message stream or shared contents or content items or web site or at least part of web site and/or accessible active links based on user preferences, privacy settings, profile, user data including information about user's actions, activities, interactions, transactions, status, location, behavior and connections.

142. The system according to claim 98, the system comprising search and match module is configured to search, match, filter, select and/or subscribe publishers, publications, categorized message streams, contents, content items, dynamic web site, at least part of published dynamic web site, lists, groups, connected or related users of user, active links from central server unit, publishers, providers, developers, user profile, connected users profiles based on one or more keywords, categories, criteria, rules, conditions, selections, type of contents, type of active links.

143. The system according to claim 98, wherein a search result comprises of a list of searched publishers with accessible metadata & parameters including publisher's profile link, publication or publishing type profile link, publisher name, publication service name, description, rank, grade, namespace, hits statistics, payment terms, metadata, date & time, language, location, domain, associated taxonomy or categories, keywords, subscribers' reviews & comments, service type including public, private, verified, paid, availability status including online, offline, away, timings and service usage details.

144. The system according to claim 98, the system comprising users are enabled to dynamically and automatically install, subscribe to or present lists for user's manual selections of one or more active links, and attach or associate active links with user profile based on user preferences, selections, search, match, subscriptions, subscribers, connections, ranks, privacy settings, user & connected users one or more subscriptions of publishers, user activities, actions, events, transactions, location, interest, behavior, user profile, user data, suggested lists, message or publication content specific active links and share selective user profile and user data with said one or more applications, services, web sites, networks, widgets, groups, networks based on privacy settings and preferences.

145. The system according to claim 98, the system comprising user is configured to create and update one or more categories lists of identified active links which are controlled by user and exist in publishing network, said creation and updation of categorized lists is based on user selection, uploaded by user, search & match, suggested & provided by connected & matched users, suggested list or auto generated by central unit based on user profiles, user data, user activities, recorded user's actions, past responses, interest, list of active links, list of active links of connected users, installed applications and provided by 3^{rd} parties developers, service providers and advertisers based on users privacy settings and preferences.

146. The system according to claim 98, the system comprising one or more senders and receivers of active link are enabled to share active link & active link associated objects and wherein said object relates to at least part of user data with one or more users based on privacy settings for communication, grouping, workflow and collaboration.

147. The system according to claim 98, the system comprising dynamic, identified & accessible active link(s) associated resource(s) are enabled to invoke, open, present in an inline, unified, in process, integrated manner, in same domain, within window or web page or browser or application or any types of presentation interface, container & widget, open in separate window, web pages, application, widget, presentation interface, container and in separate or external domain(s) or access in silent mode or accepting only user actions & clicks.

148. The system according to claim 98, the system comprising dynamic interface or container is enabled to dynamically attach, detach, enabled, disabled, host, integrate, plug, merge, combine, search, match, select, filter, connect, download, upload, subscribe, un-subscribe, install, un-install, configure, access associate profile, user data, logs, metadata, subscribers, subscriptions, connections, ranks, comments, statistics, status, user actions, set privacy settings, set presentation types including tree, list, visual, & tabular, share user data, switch, drag and drops, scroll, minimize, maximize, open, close, access, add, remove, update, upgrade, monitor, log, sort, order, rank, share, refer, bookmark, categories, synchronize, take one or more dynamic actions, invoke via URL or namespace and presents in plurality of ways, a plurality types of dynamic interfaces from plurality of sources including inputting interfaces, selection interfaces, system default interfaces, and presentation interfaces, dynamic & accessible active links including application features, applications, services, controls, multimedia data, metadata, objects, and connectable nodes of network(s) in an integrated and unified manner.
